(19) United States
(12) Patent Application Publication
(10) Pub. No.: US 2019/0245387 A1
(43) Pub. Date: Aug. 8, 2019

(54) WIRELESS POWER CONTROL METHOD AND APPARATUS FOR WIRELESS CHARGING

(71) Applicant: LG INNOTEK CO., LTD., Seoul (KR)

(72) Inventors: JAE HEE PARK, Seoul (KR); IL JONG SONG, Seoul (KR)

(73) Assignee: LG INNOTEK CO., LTD., Seoul (KR)

(21) Appl. No.: 16/315,412

(22) PCT Filed: May 22, 2017
(86) PCT No.: PCT/KR2017/005266

§ 371 Date: Jan. 4, 2019

(30) Foreign Application Priority Data
Jul. 6, 2016 (KR) 10-2016-0085485
Aug. 8, 2016 (KR) 10-2016-0100682

(51) Int. Cl. H02J 50/12; H02J 7/02

(52) U.S. Cl. CPC H02J 50/12; H02M 7/53871; H02J 7/025

(57) ABSTRACT

The present invention relates to a wireless power control method for wireless charging, and an apparatus therefor. A wireless power control method for a wireless power transmission apparatus that wirelessly transmits power to a wireless power reception apparatus according to an embodiment of the present invention may comprise the steps of: measuring the magnitude of a current flowing in a resonant circuit when power is being transmitted to the wireless power reception apparatus; comparing the measured magnitude of the current with a predetermined threshold so as to determine whether the impedance of the resonant circuit needs to be adjusted; and adjusting the impedance by altering the total inductance value of the resonant circuit if it is necessary to adjust the impedance according to the determination result. As a result, the present invention can efficiently prevent the wireless power transmission apparatus from radiating heat.

### TECHNICAL FIELD

Embodiments relate to a wireless power transmission technique, and more particularly, to a wireless power control method and apparatus for wireless charging.

### BACKGROUND ART

Recently, with rapid development of information and communication technology, a ubiquitous society based on information and communication technology is being established.

In order for information communication devices to be connected anywhere and anytime, sensors with a built-in computer chip having a communication function should be installed in all facilities throughout society. Accordingly, power supply to these devices or sensors is becoming a new challenge. In addition, as the types of mobile devices such as Bluetooth handsets and iPods, as well as mobile phones, rapidly increase in number, charging the battery has required time and effort. As a way to address this issue, wireless power transmission technology has recently drawn attention.

Wireless power transmission (or wireless energy transfer) is a technology for wirelessly transmitting electric energy from a transmitter to a receiver using the induction principle of a magnetic field. In the 1800s, an electric motor or a transformer based on the electromagnetic induction principle began to be used. Thereafter, a method of transmitting electric energy by radiating a high-frequency wave, microwave, or an electromagnetic wave such as laser was tried. Electric toothbrushes and some electric shavers are charged through electromagnetic induction.

Wireless energy transmission schemes introduced up to now may be broadly classified into electromagnetic induction, electromagnetic resonance, and RF transmission using a short-wavelength radio frequency.

In the electromagnetic induction scheme, when two coils are arranged adjacent to each other and current is applied to one of the coils, a magnetic flux generated at this time generates electromotive force in the other coil. This technology is being rapidly commercialized mainly for small devices such as mobile phones. In the electromagnetic induction scheme, power of up to several hundred kilowatts (kW) may be transmitted with high efficiency, but the maximum transmission distance is less than or equal to 1 cm. As a result, the device should be generally arranged adjacent to the charger or the floor.

The electromagnetic resonance scheme uses an electric field or a magnetic field instead of using an electromagnetic wave or current. The electromagnetic resonance scheme is advantageous in that the scheme is safe to other electronic devices or the human body since it is hardly influenced by the electromagnetic wave. However, this scheme may be used only at a limited distance and in a limited space, and has somewhat low energy transfer efficiency.

The short-wavelength wireless power transmission scheme (simply, RF transmission scheme) takes advantage of the fact that energy may be transmitted and received directly in the form of radio waves. This technology is an RF power transmission scheme using a rectenna. A rectenna, which is a compound of antenna and rectifier, refers to a device that converts RF power directly into direct current (DC) power. That is, the RF method is a technology for converting AC radio waves into DC waves. Recently, with improvement in efficiency, commercialization of RF technology has been actively researched.

The wireless power transmission technology is applicable to various industries including IT, railroads, and home appliance industries as well as the mobile industry.

As various devices are equipped with a wireless charging function and the intensity of power required by a wireless power reception device increases, heat generated in a drive circuit and a transmission coil may damage the devices.

In order to prevent heat generation, various heat dissipation structures including, for example, a heat dissipation fan and a heat dissipation material are installed in the wireless power transmission device and the wireless power reception device. However, the heat dissipation effect of such structures fails to meet expectations, and the structures are limited by cost and mechanism constraints.

In particular, it is important to quickly dissipate generated heat, but it is more important to minimize heat generated from a control circuit board and coils.

### DISCLOSURE

### Technical Problem

Therefore, the present disclosure has been made in view of the above problems, and embodiments provide a wireless power control method and apparatus for wireless charging.

Embodiments provide a wireless power control method and apparatus capable of minimizing heat generation by adaptively adjusting the impedance of a resonance circuit based on the intensity of a current applied to the resonance circuit.

Embodiments provide a wireless power control method and apparatus capable of controlling heat generation of a wireless power transmitter by adaptively adjusting the impedance of a resonance circuit based on a measured temperature of the resonance circuit.

Embodiments provide a wireless power control method and a wireless power transmitter which are capable of minimizing heat generation without interruption of charging even when it is allowed to change a power transmission mode.

The technical objects that can be achieved through the embodiments are not limited to what has been particularly described hereinabove and other technical objects not described herein will be more clearly understood by persons skilled in the art from the following detailed description.

### Technical Solution

Embodiments provide a wireless power control method and an apparatus therefor.

In one embodiment, a method of controlling wireless power in a wireless power transmission apparatus configured to wirelessly transmit power to a wireless power reception apparatus include measuring an intensity of a current flowing through a resonance circuit during power transmission to the wireless power reception apparatus, determining whether adjustment of an impedance of the resonance circuit is needed by comparing the measured intensity of the current with a predetermined threshold, and when the adjustment of the impedance is needed as a result of the determining, adjusting the impedance by changing a total inductance of the resonance circuit.

Herein, when the measured intensity of the current exceeds the threshold, the impedance may be increased by increasing the total inductance of the resonance circuit.

In addition, the total inductance of the resonance circuit may be changed using an impedance adjustment circuit provided at a front end of the resonance circuit

The resonance circuit may be a series resonance circuit configured by connecting a resonant capacitor and a resonant inductor in series.

In addition, the impedance adjustment circuit may include an impedance adjustment switch and an impedance adjustment inductor, wherein the impedance adjustment inductor may be connected in series to the series resonance circuit through control of the impedance adjustment switch to increase the total inductance of the resonance circuit.

Herein, the impedance adjustment switch may be connected to an inverter configured to provide alternating current power to the resonance circuit, the impedance adjustment switch including a first impedance adjustment switch connected in series with the impedance adjustment inductor, and a second impedance adjustment switch provided on one side of a line branched between the impedance adjustment inductor and the resonant capacitor.

Herein, the inverter may include at least one of a half-bridge inverter and a full-bridge inverter.

The method may further include outputting a predetermined warning alarm when the intensity of the current flowing through the resonance circuit does not decrease below the threshold after the impedance is increased.

In another embodiment, a method of controlling wireless power in a wireless power transmission apparatus configured to wirelessly transmit power to a wireless power reception apparatus includes measuring a temperature of a resonance circuit during power transmission to the wireless power reception apparatus, comparing the measured temperature with a predetermined threshold and determining whether adjustment of an impedance of the resonance circuit is needed, and when the adjustment of the impedance is needed as a result of the determining, adjusting the impedance by changing a total inductance of the resonance circuit.

Herein, when the measured temperature exceeds the threshold, the impedance may be increased by increasing the total inductance of the resonance circuit.

In another embodiment, a power control apparatus includes a resonance circuit, an inverter configured to provide an alternating current power to the resonance circuit, an impedance adjustment circuit provided between the inverter and the resonance circuit, the impedance adjustment circuit being configured to adjust a total impedance of the resonance circuit, a sensing unit configured to measure an intensity of a current flowing through the resonance circuit during power transmission, and a controller configured to determine whether impedance adjustment of the resonance circuit is needed by comparing the measured intensity of the current with a predetermined threshold and to adjust the total impedance of the resonance circuit by controlling the impedance adjustment circuit when the impedance adjustment is needed as a result of the determining.

Here, when the measured current intensity exceeds the threshold, the controller may control the impedance adjustment circuit to increase the total impedance of the resonance circuit to increase the total inductance of the resonance circuit.

The resonance circuit may be a series resonance circuit configured by connecting a resonant capacitor and a resonant inductor in series

In addition, the impedance adjustment circuit may include an impedance adjustment switch and an impedance adjustment inductor, wherein the impedance adjustment inductor may be connected in series to the series resonance circuit through control of the impedance adjustment switch to increase the total inductance of the resonance circuit.

Herein, the impedance adjustment switch may be connected to the inverter, the impedance adjustment switch including a first impedance adjustment switch connected in series with the impedance adjustment inductor, and a second impedance adjustment switch provided on one side of a line branched between the impedance adjustment inductor and the resonant capacitor.

Herein, the inverter may include at least one of a half-bridge inverter and a full-bridge inverter.

When the intensity of the current flowing through the resonance circuit does not decrease below the threshold after the impedance is increased, the controller may stop the power transmission and output a predetermined warning alarm

In another embodiment, a power control apparatus includes a resonance circuit, an inverter configured to provide an alternating current power to the resonance circuit, an impedance adjustment circuit provided between the inverter and the resonance circuit, the impedance adjustment circuit being configured to adjust a total impedance of the resonance circuit, a sensing unit configured to measure a temperature during power transmission, and a controller configured to determine whether adjustment of the impedance of the resonance circuit is needed by comparing the measured temperature with a predetermined threshold and to adjust the total impedance of the resonance circuit by controlling the impedance adjustment circuit when the impedance adjustment is needed as a result of the determining.

In another embodiment, a method of controlling wireless power in a wireless power transmitter configured to wirelessly transmit power to a wireless power receiver includes detecting an over-temperature during power transmission to the wireless power receiver according to a low power mode, when the over-temperature is detected, determining whether changing a power transmission mode of the wireless power transmitter to a medium power mode is allowed based on information about a required power of the wireless power receiver, when changing the power transmission mode of the wireless power transmitter to the medium power mode is not allowed, decreasing a current in a transmission coil, and when an over-temperature is detected when the current in the transmission coil reaches a threshold, boosting an output voltage of a DC/DC converter and transferring the boosted voltage to an inverter.

In another embodiment, a wireless power transmitter configured to wirelessly transmit power to a wireless power receiver includes a controller configured to determine whether changing a power transmission mode of the wireless power transmitter to a medium power mode is allowed based on information about a required power of the wireless power receiver when an over-temperature is detected during power transmission to the wireless power receiver according to a low power mode, and a voltage regulator configured to boost an output voltage of a DC/DC converter and transfer the boosted voltage to an inverter when an over-temperature is detected when a current in a transmission coil reaches a threshold.

In another embodiment, there is provided a computer-readable recording medium having recorded thereon a program for executing any one of the above-mentioned wireless power control methods.

The above-described aspects of the present disclosure are merely a part of preferred embodiments of the present disclosure. Those skilled in the art will derive and understand various embodiments reflecting the technical features of the present disclosure from the following detailed description of the present disclosure.

### Advantageous Effects

A method, apparatus and system according to embodiments have the following effects.

Embodiments provide a wireless power control method and apparatus capable of preventing heat generation in a wireless power transmission apparatus.

Embodiments provide a wireless power control method and apparatus capable of minimizing heat generation by adaptively adjusting the impedance of a resonance circuit based on the intensity of a current applied to the resonance circuit.

Further, embodiments provide a wireless power control method and apparatus capable of blocking excessive current from flowing to a resonance circuit by adaptively adjusting the impedance of the resonance circuit based on a measured temperature of the resonance circuit.

Embodiments provide a wireless power control method and apparatus capable of preventing interruption of charging during adjustment according to heat generation of a wireless power transmission apparatus.

The present disclosure may minimize heat generation while maintaining a power transmission state without interruption of charging even when an over-temperature condition occurs during power transmission to a wireless power receiver that supports only a low power mode.

It will be appreciated by those skilled in the art that that the effects that can be achieved through the embodiments of the present disclosure are not limited to those described above and other advantages of the present disclosure will be more clearly understood from the following detailed description.

### DESCRIPTION OF DRAWINGS

FIG. 1 is a block diagram illustrating a wireless charging system according to an embodiment.

FIG. 2 is a block diagram illustrating a wireless charging system according to another embodiment.

FIG. 3 is a diagram illustrating a detection signal transmission procedure in a wireless charging system according to an embodiment.

FIG. 4 is a state transition diagram illustrating a wireless power transmission procedure defined in the WPC standard.

FIG. 5 is a state transition diagram illustrating a wireless power transmission procedure defined in the WPC (Qi) standard.

FIG. 6 is a block diagram illustrating a structure of a wireless power transmitter according to an embodiment.

FIG. 7 is a block diagram illustrating a structure of a wireless power receiver operatively connected with the wireless power transmitter according to the FIG. 6.

FIG. 8 is a diagram illustrating a method of modulation and demodulation of a wireless power signal according to an embodiment.

FIG. 9 illustrates a packet format according to an embodiment.

FIG. 10 illustrates the types of packets defined in the WPC (Qi) standard according to an embodiment.

FIG. 11 is a block diagram illustrating a structure of a wireless power control apparatus according to an embodiment.

FIG. 12 is a diagram for explaining the basic operation principle of an inverter configured to convert a DC signal into an AC signal in order to facilitate understanding of the present disclosure.

FIG. 13 is an equivalent circuit diagram of a wireless power control apparatus equipped with a half-bridge type inverter according to an embodiment.

FIG. 14 is an equivalent circuit diagram of a wireless power control apparatus equipped with a full-bridge inverter according to another embodiment.

FIG. 15 is a flowchart illustrating a wireless power control method according to an embodiment.

FIG. 16 is a flowchart illustrating a wireless power control method according to another embodiment.

FIG. 17 is a flowchart illustrating a wireless power control method according to still another embodiment.

FIG. 18 is a block diagram illustrating a voltage regulator of a wireless power transmitter according to an embodiment.

FIG. 19 is a circuit diagram showing a voltage regulator according to an embodiment.

FIG. 20 is a diagram illustrating operation of the voltage regulator of FIG. 9 in a normal mode.

FIG. 21 is a diagram illustrating operation of the voltage regulator of FIG. 9 in a boost mode.

FIG. 22 is a flowchart illustrating operation of a wireless power transmitter according to an embodiment.

### BEST MODE

A method of controlling wireless power in a wireless power transmission apparatus configured to wirelessly transmit power to a wireless power reception apparatus according to an embodiment may include measuring an intensity of a current flowing through a resonance circuit during power transmission to the wireless power reception apparatus, determining whether impedance adjustment of the resonance circuit is needed by comparing the measured intensity of the current with a predetermined threshold, when the impedance adjustment is needed as a result of the determining, adjusting the impedance by changing a total inductance of the resonance circuit.

### MODE FOR INVENTION

Hereinafter, an apparatus and various methods to which embodiments of the present disclosure are applied will be described in detail with reference to the drawings. As used herein, the suffixes “module” and “unit” are added or used interchangeably to facilitate preparation of this specification and are not intended to suggest distinct meanings or functions.

In the description of the embodiments, it is to be understood that, when an element is described as being “on”/“over” or “beneath”/“under” another element, the two elements may directly contact each other or may be arranged with one or more intervening elements present therebetween. Also, the terms “on”/“over” or “beneath”/“under” may refer to not only an upward direction but also a downward direction with respect to one element.

For simplicity, in the description of the embodiments, “wireless power transmitter,” “wireless power transmission apparatus,” “transmission end,” “transmitter,” “transmission apparatus,” “transmission side,” “wireless power transfer apparatus,” “wireless power transferer,” and the like will be used interchangeably to refer to an apparatus equipped with a function of transmitting wireless power in a wireless charging system. In addition, “wireless power reception apparatus,” “wireless power receiver,” “reception end,” “reception side,” “reception apparatus,” “receiver,” and the like will be used interchangeably to refer to an apparatus equipped with a function of receiving wireless power from a wireless power transmission apparatus.

The transmitter according to the present disclosure may be configured as a pad type, a cradle type, an access point (AP) type, a small base station type, a stand type, a ceiling embedded type, a wall-mounted type, or the like. One transmitter may transmit power to a plurality of wireless power reception apparatuses. To this end, the transmitter may include at least one wireless power transmission means. Here, the wireless power transmission means may employ various wireless power transmission standards which are based on the electromagnetic induction scheme for charging according to the electromagnetic induction principle meaning that a magnetic field is generated in a power transmission end coil and current is induced in a reception end coil by the magnetic field. Here, the wireless power transmission means may include wireless charging technology using electromagnetic induction schemes defined by the Wireless Power Consortium (WPC) and the Power Matters Alliance (PMA), which are wireless charging technology standard organizations.

In addition, a receiver according to an embodiment of the present disclosure may include at least one wireless power reception means, and may receive wireless power from two or more transmitters simultaneously. Here, the wireless power reception means may include wireless charging technologies of electromagnetic induction schemes defined by the Wireless Power Consortium (WPC) and the Power Matters Alliance (PMA), which are wireless charging technology standard organizations.

The receiver according to the present disclosure may be employed in small electronic devices including a mobile phone, a smartphone, a laptop computer, a digital broadcasting terminal, a Personal Digital Assistant (PDA), a Portable Multimedia Player (PMP), a navigation device, an electric toothbrush, an electronic tag, a lighting device, a remote control, a fishing float, and wearable devices such as a smart watch. However, the embodiments are not limited thereto. The applications may include any devices which are equipped with a wireless power transmission means and have a rechargeable battery.

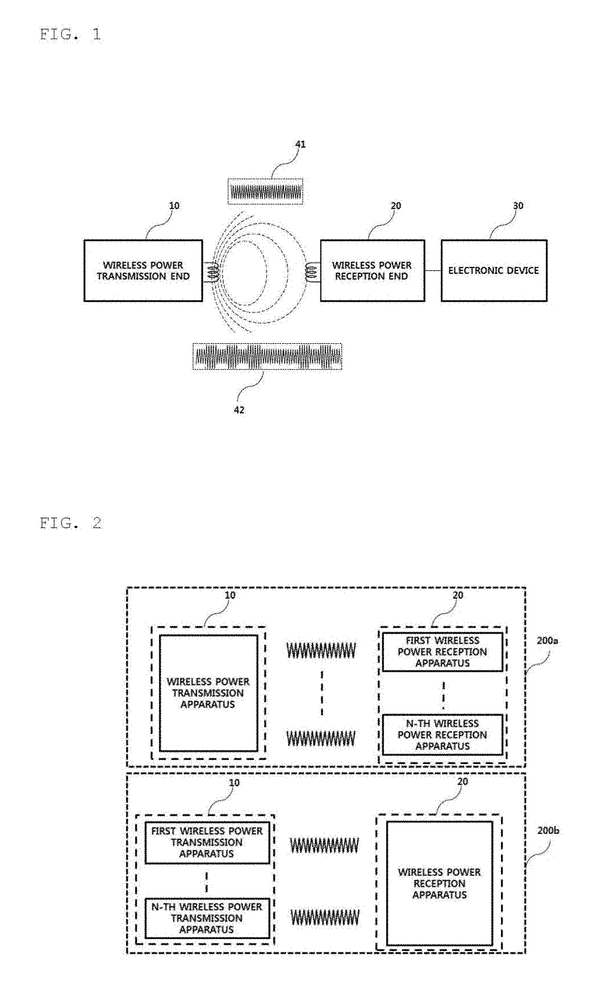

FIG. 1 is a block diagram illustrating a wireless charging system according to an embodiment.

Referring to FIG. 1, the wireless charging system may include a wireless power transmission end 10 configured to wirelessly transmit power, a wireless power reception end 20 configured to receive the transmission power, and an electronic device 30 configured to be supplied with the received power.

In an example, the wireless power transmission end 10 and the wireless power reception end 20 may perform in-band communication, in which information is exchanged using the same frequency band as the operating frequency used for wireless power transmission. In another example, the wireless power transmission end 10 and the wireless power reception end 20 may perform out-of-band communication, in which information is exchanged using a separate frequency band different from the operating frequency used for wireless power transmission.

For example, the information exchanged between the wireless power transmission end 10 and the wireless power reception end 20 may include control information as well as state information about the terminals. Here, the state information and the control information exchanged between the transmission end and the reception end will be clarified through the embodiments which will be described later.

The in-band communication and the out-of-band communication may provide bidirectional communication, but embodiments are not limited thereto. In another embodiment, the in-band communication and the out-of-band communication may provide unidirectional communication or half-duplex communication.

For example, the unidirectional communication may be used for the wireless power reception end 20 to transmit information only to the wireless power transmission end 10, but embodiments are not limited thereto. The unidirectional communication may be used for the wireless power transmission end 10 to transmit information to the wireless power reception end 20.

In the half duplex communication, bidirectional communication may be performed between the wireless power reception end 20 and the wireless power transmission end 10, but only one apparatus may be allowed to transmit information at a certain point in time.

The wireless power reception end 20 according to an embodiment may acquire various kinds of state information about an electronic device 30. For example, the state information about the electronic device 30 may include current power usage information, information for identifying an application that is being executed, CPU usage information, battery charging state information, and battery output voltage/current information, but embodiments are not limited thereto. The state information may include any information that may be acquired from the electronic device 30 and available for wireless power control.

In particular, according to an embodiment of the present disclosure, the wireless power transmission end 10 may transmit, to the wireless power reception end 20, a predetermined packet indicating whether fast charging is supported. When it is determined that the connected wireless power transmission end 10 supports the fast charging mode, the wireless power reception end 20 may notify the electronic device 30 of the supportability. The electronic device 30 may indicate that fast charging is allowed through a predetermined provided display means, for example, a liquid crystal display.

In addition, the user of the electronic device 30 may select a predetermined fast charging request button displayed on the liquid crystal display means to control the wireless power transmission end 10 to operate in the fast charging mode. In this case, when the fast charging request button is selected by the user, the electronic device 30 may transmit a predetermined fast charging request signal to the wireless power reception end 20. The wireless power reception end 20 may generate a charging mode packet corresponding to the received fast charging request signal and transmit the packet to the wireless power transmission end 10 to switch the general low power charging mode to the fast charging mode.

FIG. 2 is a block diagram illustrating a wireless charging system according to another embodiment.

For example, as shown in the section indicated by reference numeral 200a, the wireless power reception end 20 may include a plurality of wireless power reception apparatuses, and the plurality of wireless power reception apparatuses may be connected to one wireless power transmission end 10 to perform wireless charging. In this case, the wireless power transmission end 10 may distribute and transmit power to the plurality of wireless power reception apparatuses in a time division manner, but embodiments are not limited thereto. In another example, the wireless power transmission end 10 may distribute and transmit power to the plurality of wireless power reception apparatuses using different frequency bands allocated to the respective wireless power reception apparatuses.

Here, the number of wireless power reception apparatuses connectable to one wireless power transmission apparatus 10 may be adaptively determined based on at least one of a required power for each wireless power reception apparatus, a battery charging state, a power consumption amount of the electronic device, and an available power of the wireless power transmission apparatus.

As another example, as shown in the section indicated by reference numeral 200b, the wireless power transmission end 10 may include a plurality of wireless power transmission apparatuses. In this case, the wireless power reception end 20 may be connected to a plurality of wireless power transmission apparatuses simultaneously, and may receive power from the connected wireless power transmission apparatuses simultaneously to perform charging. Here, the number of wireless power transmission apparatuses connected to the wireless power reception end 20 may be adaptively determined based on a required power of the wireless power reception end 20, a battery charging state, a power consumption amount of the electronic device, an available power of the wireless power transmission apparatus, and the like.

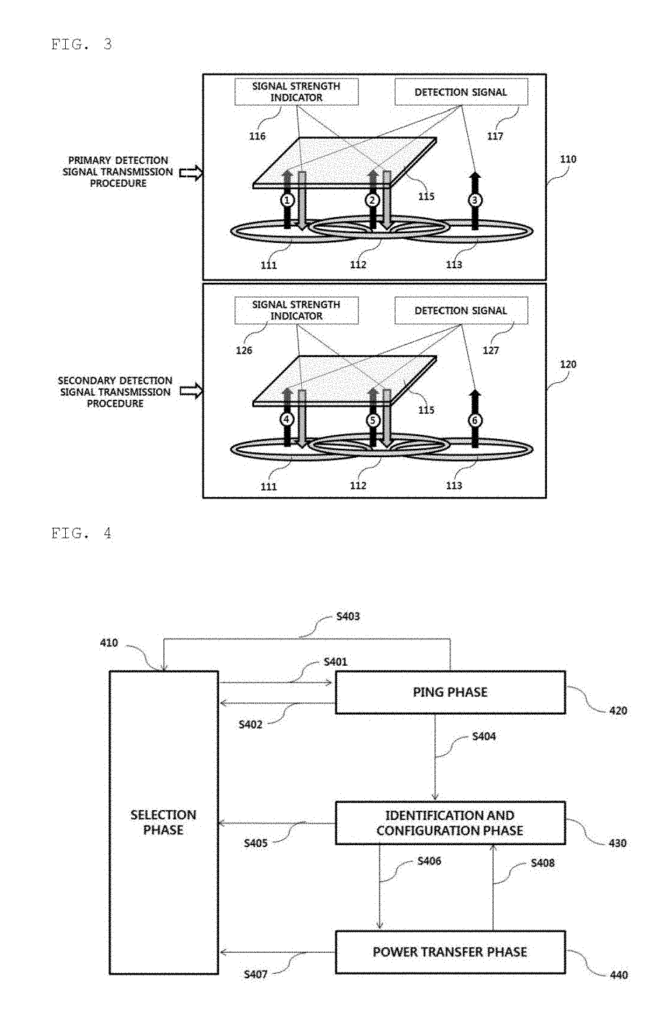

FIG. 3 is a diagram illustrating a procedure of transmitting a detection signal in a wireless charging system according to an embodiment.

As an example, the wireless power transmitter may be equipped with three transmission coils 111ii, 112 and 113. Each transmission coil may have a region partially overlapping the other transmission coils, and the wireless power transmitter sequentially transmits predetermined detection signals 117 and 127, for example, digital ping signals, for detecting presence of a wireless power receiver through the respective transmission coils in a predefined order.

As shown in FIG. 3, the wireless power transmitter may sequentially transmit detection signals 117 through a primary detection signal transmission procedure, which is shown in the section indicated by reference numeral 110, and identify transmission coils 111 and 112 through which a signal strength indicator 116 is received from the wireless power receiver 115. Subsequently, the wireless power transmitter may sequentially transmit detection signals 127 through a secondary detection signal transmission procedure, which is shown in the section indicated by reference numeral 120, identify a transmission coil exhibiting better power transmission efficiency (or charging efficiency), namely better alignment with the reception coil, between the transmission coils 111 and 112 through which the signal strength indicator 126 is received, and perform a control operation to transmit power through the identified transmission coil, that is, to perform wireless charging.

The wireless power transmitter performs the detection signal transmission procedure twice as shown in FIG. 3 in order to more accurately identify a transmission coil that is better aligned with the reception coil of the wireless power receiver.

When the signal strength indicators 116 and 126 are received by the first transmission coil 111 and the second transmission coil 112 as shows in the sections indicated by reference numerals 110 and 120 of FIG. 3, the wireless power transmitter selects a transmission coil exhibiting the best alignment based on the signal strength indicator 126 received by each of the first transmission coil. 111 and the second transmission coil 112 and performs wireless charging using the selected transmission coil.

FIG. 4 is a state transition diagram illustrating a wireless power transmission procedure defined in the WPC standard.

Referring to FIG. 4, power transmission from a transmitter to a receiver according to the WPC standard may be broadly divided into a selection phase 410, a ping phase 420, an identification and configuration phase 430, and a power transfer phase 440.

The selection phase 410 may be a phase entered through transition when a specific error or a specific event is detected while power transmission begins or is maintained. Here, the specific error and the specific event will be clarified through the following description. In the selection phase 410, the transmitter may monitor whether an object is present on the surface of the charging interface. When the transmitter detects an object being placed on the surface of the charging interface, it may transition to the ping phase 420 (S401). In the selection phase 410, the transmitter may transmit an analog ping signal of a very short pulse and detect whether an object is present in the active area, i.e., the charging-allowed area, of the charging interface surface based on the change in current in the transmission coils.

When the transmitter detects an object in the ping phase 42G, it activates, i.e., boots, the receiver and transmits a digital ping to identify whether the receiver is a WPC standard-compatible receiver. In a case where the transmitter does not receive a response signal (e.g., a signal strength indicator) for the digital ping from the receiver in the ping phase 420, it may transition back to the selection phase 410 (S402). In addition, when the transmitter receives, from the receiver, a signal indicating completion of power transmission, that is, a charge completion signal, in the ping phase 420, the transmitter may transition to the selection phase 410 (S403).

Once the ping phase 420 is complete, the transmitter may transition to the identification and configuration phase 430 for identifying the receiver and collecting configuration and state information about the receiver (S404).

In the identification and configuration phase 430, when an unexpected packet is received (unexpected packet), a desired packet is not received for a predefined time (timeout), there is an error in packet transmission (transmission error), or no power transfer contract is made (no power transfer contract), the transmitter may transition to the selection phase 410 (S405).

Once identification and configuration of the receiver are complete, the transmitter may transition to the power transfer phase 440 for transmitting wireless power (S406).

In the power transfer phase 440, when an unexpected packet is received (unexpected packet), a desired packet is not received for a predefined time (timeout), a violation of a pre-established power transmission contract occurs (power transfer contract violation), and charging is complete, the transmitter may transition to the selection phase 410 (S407).

In addition, in the power transfer phase 440, when the power transfer contract needs to be reconfigured according to change in the state of the transmitter or the like, the transmitter may transition to the identification and configuration phase 430 (S408).

The above-described power transmission contract may be set based on the state and characteristics information about the transmitter and the receiver. For example, the transmitter state information may include information on a maximum amount of transmittable power and information on a maximum number of acceptable receivers, and the receiver state information may include information about the required power.

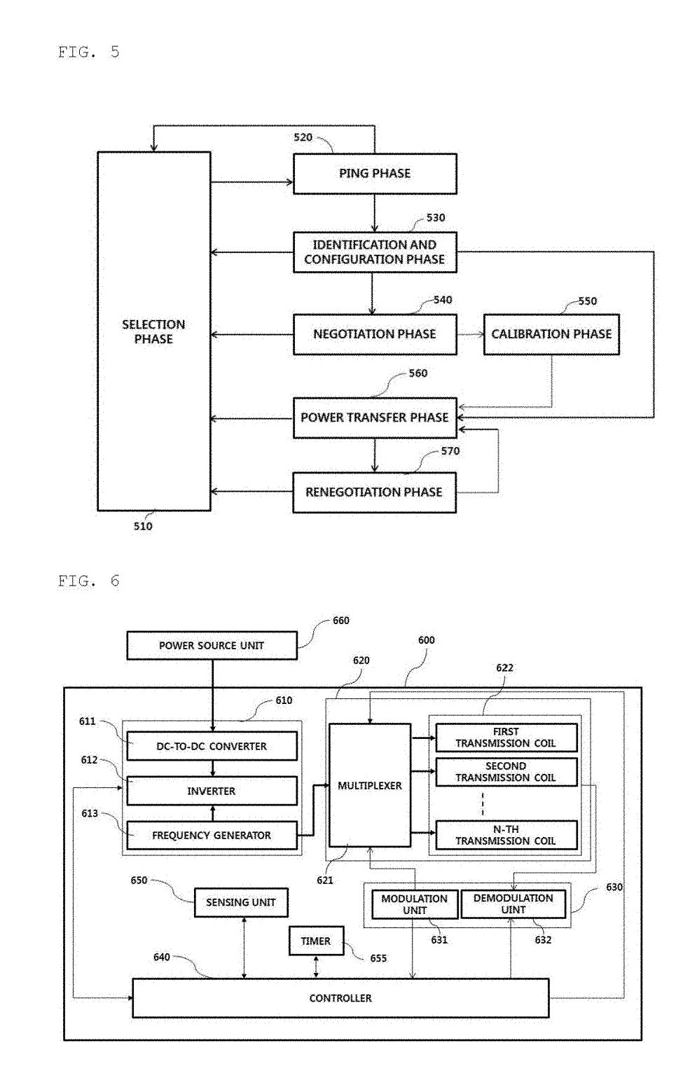

FIG. 5 is a state transition diagram illustrating a wireless power transmission procedure defined in the WPC (Qi) standard.

Referring to FIG. 5, power transmission from a transmitter to a receiver according to the WPC (Qi) standard may be broadly divided into a selection phase 510, a ping phase 520, an identification and configuration phase, 530, a negotiation phase 540, a calibration phase 550, a power transfer phase 560, and a renegotiation phase 570.

The selection phase 510 may be a phase which transitions to another phase (e.g., S502, S504, S506, S509) when a specific error or a specific event is detected while power transmission begins or is maintained. Here, the specific error and the specific event will be clarified through the following description. Further, in the selection phase 510, the transmitter may monitor whether an object is present at the interface surface. When the transmitter detects an object being placed on the interface surface, it may transition to the ping phase 520. In the selection phase 510, the transmitter may transmit an analog ping signal of a very short pulse and detect whether an object is present in the active area of the interface surface based on the change in current in the transmission coil or the primary coil.

When the transmitter detects an object in the ping phase 520, it activates the receiver and transmits a digital ping to identify whether the receiver is a WPC standard-compatible receiver. In a case where the transmitter does not receive a response signal (e.g., a signal strength packet) for the digital ping from the receiver in the ping phase 520, it may transition back to the selection phase 510. In addition, when the transmitter receives, from the receiver, a signal indicating completion of power transmission, that is, a charge completion packet in the ping phase 520, the transmitter may transition to the selection phase 510.

Once the ping phase 520 is complete, the transmitter may transition to the identification and configuration phase 530 for identifying the receiver and collecting configuration and state information about the receiver.

In the identification and configuration phase 530, when an unexpected packet is received (unexpected packet), a desired packet is not received for a predefined time (timeout), there is an error in packet transmission (transmission error) or no power transfer contract is made (no power transfer contract), the transmitter may transition to the selection phase 510.

The transmitter may check whether entering the negotiation phase 540 is needed based on the value of the negotiation field in the configuration packet received in the identification and configuration phase 530.

When a negotiation is needed as a result of checking, the transmitter may enter the negotiation phase 540 and perform a predetermined FOD procedure.

On the other hand, when a negotiation is not needed as a result of checking, the transmitter may immediately enter the power transfer phase 560.

In the negotiation phase 540, the transmitter may receive a foreign object detection (EOD) status packet including a value of a reference quality factor. Then, the transmitter may determine a threshold for FO detection based on the value of the reference quality factor.

The transmitter may detect whether an FO is present in the charging area using the determined threshold for FO detection and the currently measured quality factor value, and control power transmission according to the FO detection result. In one example, when an FO is detected, power transmission may be interrupted, but embodiments are not limited thereto.

When an FO is detected, the transmitter may return to the selection phase 510. On the other hand, when no FO is detected, the transmitter may enter the power transfer phase 560 via the calibration phase 550. Specifically, when no FO is detected, the transmitter may determine, in the calibration phase 550, the intensity of power received by the reception end, and measure power loss at the reception end and the transmission end to determine the intensity of power transmitted from the transmission end. That is, in the calibration phase 550, the transmitter may predict power loss based on the difference between the transmission power of the transmission end and the received power of the reception end. According to an embodiment, the transmitter may calibrate the threshold for FOD in consideration of the predicted power loss.

In the power transfer phase 560, when an unexpected packet is received (unexpected packet), a desired packet is not received for a predefined time (timeout), a violation of a pre-established power transmission contract occurs (power transfer contract violation), and charging is complete, the transmitter may transition to the selection phase 510.

In addition, in the power transfer phase 560, when the power transfer contract needs to be reconfigured according to change in the state of the transmitter or the like, the transmitter may transition to the renegotiation phase 570. In this case, when the renegotiation is normally completed, the transmitter may return to the power transfer phase 560.

The above-described power transmission contract may be set based on the state and characteristics information about the transmitter and the receiver. For example, the transmitter state information may include information on a maximum amount of transmittable power and information on a maximum number of acceptable receivers, and the receiver state information may include information on the required power.

FIG. 6 is a block diagram illustrating a structure of a wireless power transmitter according to an embodiment.

Referring to FIG. 6, the wireless power transmitter 600 may include a power conversion unit 610, a power transmission unit 620, a communication unit 630, a controller 640, and a sensing unit 650. It should be noted that the elements of the wireless power transmitter 600 described above are not necessarily essential elements, and thus the wireless power transmitter may be configured to include more or fewer elements.

As shown in FIG. 6, when DC power is supplied from a power source unit 660, the power conversion unit 610 may function to convert the power into AC power having a predetermined intensity.

To this end, the power conversion unit 610 may include a DC/DC converter 611, an inverter 612, and a frequency generator 613. Here, the inverter 612 may be a half-bridge inverter or a full-bridge inverter. However, embodiments are not limited thereto. The inverter may be any circuit configuration capable of converting DC power into AC power having a specific operating frequency is sufficient.

The DC/DC converter 611 may function to convert DC power supplied from the power source unit 650 into DC power having a specific intensity according to a control signal of the controller 640.

Then, the sensing unit 650 may measure the voltage/current of the DC-converted power and provide the measured voltage/current to the controller 640. In addition, the sensing unit 650 may measure the internal temperature of the wireless power transmitter 600 and provide the result of the measurement to the controller 640 in order to determine whether an over-temperature condition has occurred. For example, the controller 640 may adaptively cut off power supplied from the power source unit 650 or cut off power supplied to the amplifier 612, based on the voltage/current value measured by the sensing unit 650. To this end, a predetermined power cutoff circuit may be further provided on one side of the power conversion unit 610 to cut off power supplied from the power source unit 650 or to cut off power supplied to the amplifier 612.

The inverter 612 may convert the DC/DC-converted DC power into AC power based on a reference AC signal generated by the frequency generator 613. Here, the frequency of the reference AC signal, i.e., the operating frequency, may be dynamically changed according to the control signal of the controller 640. The wireless power transmitter 600 according to the embodiment of the present disclosure may adjust the operating frequency to adjust the intensity of transmitted power. For example, the controller 640 may receive power reception state information about the wireless power receiver and/or a power control signal through the communication unit 630, and may determine an operating frequency based on the received power reception state information and/or power control information and dynamically control the frequency generator 613 to generate the determined operating frequency. For example, the power reception state information may include, but is not limited to, intensity information about the rectifier output voltage and intensity information about the current applied to the reception coil. The power control signal may include a signal for requesting increase of power and a signal for requesting decrease of power.

The power transmission unit 620 may include a multiplexer 621 and a transmission coil unit 622. Here, the transmission coil unit 622 may include first to n-th transmission coils. The power transmission unit 620 may further include a carrier generator (not shown) configured to generate a specific carrier frequency for power transmission. In this case, the carrier generator may generate a specific carrier frequency for mixing with the output AC power of the inverter 612 received through the multiplexer 621. It should be noted that the frequencies of the AC power delivered to the respective transmission coils may be different from each other in one embodiment of the present disclosure. In another embodiment of the present disclosure, the resonance frequency may be set differently for each transmission coil using a predetermined frequency controller having a function of adjusting the LC resonance property differently for the respective transmission coils.

The multiplexer 621 may perform a switch function to transmit AC power to a transmission coil selected by the controller 640. The controller 640 may select a transmission coil to be used for power transmission to the wireless power receiver based on the signal strength indicators received for the respective transmission coils.

When a plurality of wireless power receivers are connected, the controller 640 according to an embodiment of the present disclosure may transmit power by time division multiplexing for each transmission coil. For example, when three wireless power receivers, i.e., first to third wireless power receivers, are each identified by the wireless power transmitter 600 through three different transmission coils, i.e., first to third transmission coils, the controller 640 may control the multiplexer 621 such that AC power can be transmitted through only a specific transmission coil in a specific time slot. Here, the amount of power to be transmitted to the corresponding wireless power receiver may be controlled according to the length of the time slot allocated to each transmission coil, but this is merely one embodiment. In another embodiment, the intensity of the AC output power of the DC/DC converter 611 may be controlled during a time slot allocated to each transmission coil to control transmitted power for each wireless power receiver.

The controller 640 may control the multiplexer 621 so as to sequentially transmit the detection signals through the first to n-th transmission coils 622 during the primary detection signal transmission procedure. In this case, the controller 640 may identify, through the timer 655, a time to transmit a detection signal. When the time reaches the detection signal transmission time comes, the controller 640 may control the multiplexer 621 to transmit the detection signals through the corresponding transmission coils. For example, the timer 650 may transmit a specific event signal to the controller 640 at predetermined intervals during the ping transmission phase. Every time the event signal is detected, the controller 640 may control the multiplexer 621 to transmit the digital ping through the corresponding transmission coil.

In addition, during the primary detection signal transmission procedure, the controller 640 may receive a predetermined transmission coil identifier for identifying a transmission coil through which a signal strength indicator has been received from the demodulation unit 632 and the signal strength indicator received through the corresponding transmission coil. Subsequently, in the secondary detection signal transmission procedure, the controller 640 may control the multiplexer 621 such that the detection signal may be transmitted only through the transmission coil(s) through which the signal strength indicator has been received during the primary detection signal transmission procedure. In another example, when there is a plurality of transmission coils through which the signal strength indicators have been received during the first differential detection signal transmission procedure, the controller 640 may determine a transmission coil through which a signal strength indicator having the greatest value has been received as a transmission coil to be used first to transmit a detection signal in the secondary detection signal transmission procedure, and control the multiplexer 621 according to the result of the determination.

The communication unit 630 may include at least one of a modulation unit 631 and a demodulation unit 632.

The modulation unit 631 may modulate the control signal generated by the controller 640 and transfer the modulated control signal to the multiplexer 621. Here, the modulation schemes for modulating the control signal may include, but is not limited to, frequency shift keying (FSK), Manchester coding, phase shift keying (PSK), pulse width modulation, and differential bi-phase modulation.

When a signal received through a transmission coil is detected, the demodulation unit 632 may demodulate the detected signal and transmit the demodulated signal to the controller 640. Here, the demodulated signal may include a signal strength indicator, an error correction (EC) indicator for power control during wireless power transmission, an EOC (end of charge) indicator, and an overvoltage/overcurrent/over-temperature indicator, but embodiments are not limited thereto. The demodulated signal may include various kinds of state information for identifying the state of the wireless power receiver.

In addition, the demodulation unit 632 may identify a transmission coil through which the demodulated signal has been received, and provide the controller 640 with a predetermined transmit coil identifier corresponding to the identified transmission coil.

The demodulation unit 632 may also demodulate the signal received through the transmission coil 623 and transmit the demodulated signal to the controller 640. In one example, the demodulated signal may include, but is not limited to, a signal strength indicator. The demodulated signal may include various kinds of state information about the wireless power receiver.

In one example, the wireless power transmitter 600 may acquire the signal strength indicator through in-band communication that uses the same frequency as used for wireless power transmission to communicate with the wireless power receiver.

In addition, the wireless power transmitter 600 may not only transmit wireless power using the transmission coil unit 622, but also exchange various kinds of control signals and state information with the wireless power receiver through the transmission coil unit 622. In another example, it should be noted that the wireless power transmitter 600 may further include separate coils corresponding to each of the first to n-th transmission coils of the transmission coil unit 622 and perform in-band communications with the wireless power receiver using the separate coils.

According to another embodiment of the present disclosure, the wireless power transmitter 600 may further include a voltage regulator (not shown) configured to output DC power of a specific intensity supplied from the DC/DC converter 611 as it is according to a control signal of the controller 640 or to output DC power obtained by boosting the supplied DC power to another intensity. For example, the voltage regulator may be disposed between the DC/DC converter 611 and the inverter 612, and the configuration and operation of the voltage regulator will be described in detail with reference to FIGS. 18 to 22, which will be described later.

Although FIG. 6 illustrates that the wireless power transmitter 600 and the wireless power receiver perform in-band communication, this is merely one embodiment. The transmitter and the receiver may perform short-range bidirectional communication through a frequency band different from the frequency band used for transmission of wireless power signals. For example, the short-range bidirectional communication may be any one of low-power Bluetooth communication, RFID communication, UWB communication, and ZigBee communication.

In addition, although FIG. 6 illustrates that the power transmission unit 620 of the wireless power transmitter 600 includes the multiplexer 621 and a plurality of transmission coils 622, this is merely one embodiment. It should be noted that the power transmission unit 620 may be composed of one transmission coil in another embodiment.

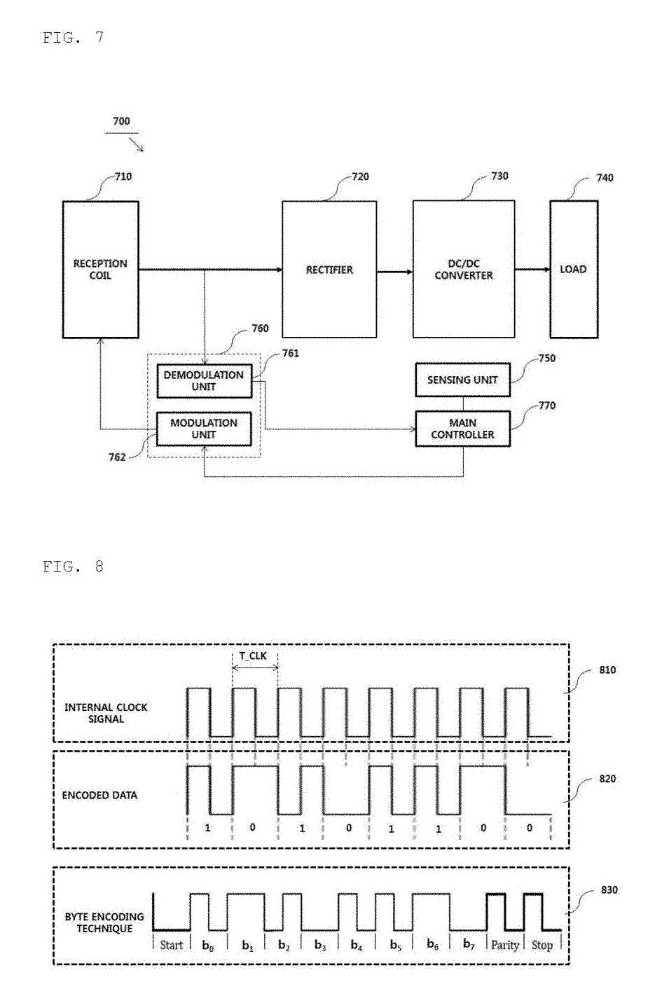

FIG. 7 is a block diagram illustrating a structure of a wireless power receiver operatively connected with the wireless power transmitter according to the FIG. 6.

Referring to FIG. 7, the wireless power receiver 700 may include a reception coil 710, a rectifier 720, a DC/DC converter 730, a load 740, a sensing unit 750, a communication unit 760, and a main controller 770. Here, the communication unit 760 may include at least one of a demodulation unit 761 and a modulation unit 762.

Although the wireless power receiver 700 is illustrated in FIG. 7 as being capable of exchanging information with the wireless power transmitter 600 through in-band communication, this is merely one embodiment. According to another embodiment of the present disclosure, the communication unit 760 may provide short-range bidirectional communication through a frequency band different from the frequency band used for transmission of wireless power signals.

The AC power received via the reception coil 710 may be transferred to the rectifier 720. The rectifier 720 may convert the AC power to DC power and transmit the DC power to the DC/DC converter 730. The DC/DC converter 730 may convert the intensity of the rectifier output DC power to a specific intensity required by the load 740 and then deliver the converted power to the load 740.

The sensing unit 750 may measure the intensity of the DC power output from the rectifier 720 and may provide the measured DC power to the main controller 770. In addition, the sensing unit 750 may measure the intensity of the current applied to the reception coil 710 according to the wireless power reception, and may transmit the result of the measurement to the main controller 770. Further, the sensing unit 750 may measure the internal temperature of the wireless power receiver 700 and provide the measured temperature to the main controller 770.

For example, the main controller 770 may compare the intensity of the measured rectifier output DC power with a predetermined reference value to determine whether an overvoltage is generated. When an overvoltage has been generated as a result of the determination, the main controller may generate a predetermined packet indicating that an overvoltage has occurred and transmit the packet to the modulation unit 762. Here, the signal modulated by the modulation unit 762 may be transmitted to the wireless power transmitter 600 through the reception coil 710 or a separate coil (not shown). Further, when the intensity of the rectifier output DC power is greater than or equal to a predetermined reference value, the main controller 770 may determine that the detection signal has been received. When the detection signal is received, the main controller may control the signal strength indicator corresponding to the detection signal to be transmitted to the wireless power transmitter 600 through the modulation unit 762. In another example, the demodulation unit 761 may demodulate an AC power signal between the reception coil 710 and the rectifier 720 or a DC power signal output from the rectifier 720 to identify whether or not the detection signal has been received, and then provide the result of the identification to the main controller 770. Then, the main controller 770 may control a signal strength indicator corresponding to the detection signal to be transmitted through the modulation unit 762.

FIG. 8 is a diagram illustrating a method of modulation and demodulation of a wireless power signal according to an embodiment.

As shown in a section indicated by reference numeral 810 in FIG. 8, the wireless power transmission end 10 and the wireless power reception end 20 may encode or decode a packet to be transmitted based on an internal clock signal having the same periodicity.

Hereinafter, a method of encoding a packet to be transmitted will be described in detail with reference to FIGS. 1 to 8.

Referring to FIG. 1, when the wireless power transmission end 10 or the wireless power reception end 20 does not transmit a specific packet, the wireless power signal may be an alternating current signal of a specific frequency that is not modulated, as shown in the section indicated by reference numeral 41 in FIG. 1. On the other hand, when the wireless power transmission end 10 or the wireless power reception end 20 transmits the specific packet, the wireless power signal may be an AC signal modulated in a specific modulation scheme, as shown in the section indicated by reference numeral 42 in FIG. 1. For example, the modulation scheme may include, but is not limited to, an amplitude modulation scheme, a frequency modulation scheme, a frequency and amplitude modulation scheme, and a phase modulation scheme.

The binary data of the packet generated by the wireless power transmission end 10 or the wireless power reception end 20 may be subjected to differential bi-phase encoding as shown in the section indicated by reference numeral 820. Specifically, the differential bi-stage encoding undergoes two state transitions to encode data bit 1 and undergoes one state transition to encode data bit 0. That is, the data bit 1 may be encoded such that transition between state HI and state LO occurs at the rising edge and the falling edge of the clock signal, and data bit 0 may be encoded such that transition between state HI and state LO occurs at HI at the rising edge of the clock signal.

A byte encoding technique may be applied to the encoded binary data, as shown in the section indicated by reference numeral 830. Referring to the section indicated by reference numeral 830, a byte encoding technique according to an embodiment of the present disclosure may be a technique of inserting a start bit and a stop bit for identifying start and stop of a 8-bit encoded binary bitstream and a parity bit for detecting whether an error has occurred in the bitstream (in byte).

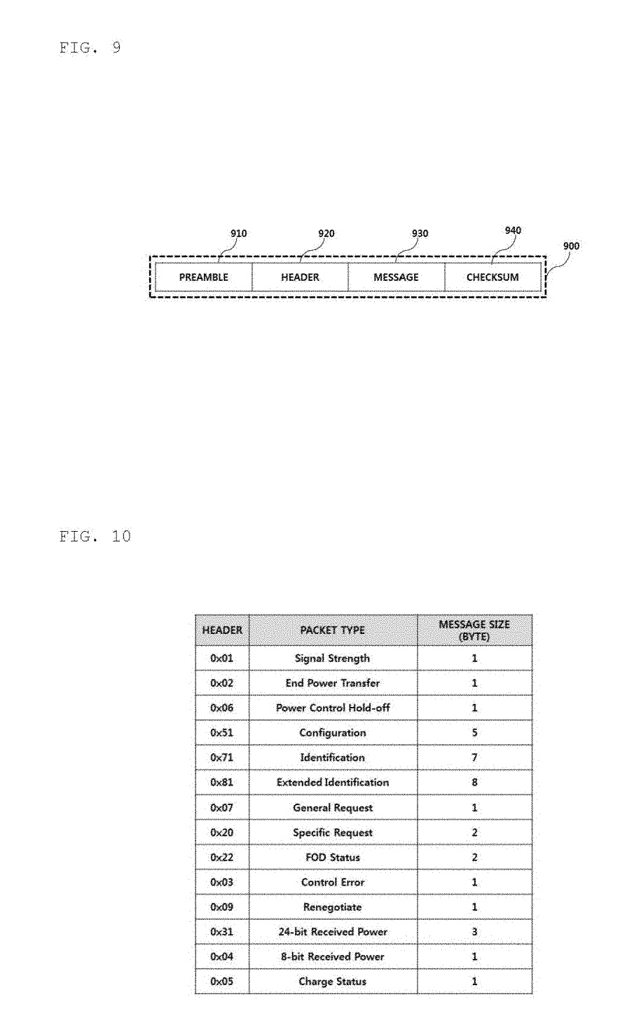

FIG. 9 illustrates a packet format according to an embodiment.

Referring to FIG. 9, a packet format 900 used for information exchange between the wireless power transmission end 10 and the wireless power reception end 20 may include a preamble field 910 for acquiring synchronization for demodulation of the packet and identifying an accurate start bit of the packet, a header field 920 for identifying the type of a message included in the packet, a message field 930 for transmitting the content of the packet (or a payload), and a checksum field 940 for checking whether an error has occurred in the packet.

The packet reception end may identify the size of the message 930 included in the packet based on the value of the header 920.

In addition, the header 920 may be defined for each phase of the wireless power transmission procedure. The header 920 may be defined to have the same value in different phases of the wireless power transmission procedure. For example, referring to FIG. 10, it should be noted that the header value corresponding to the End Power Transfer in the ping phase and the header value corresponding to the End Power Transfer in the power transfer phase may all be 0x02.

The message 930 includes data to be transmitted at the transmitting end of the packet. For example, the data contained in the message field 930 may be, but is not limited to, a report, a request, or a response to the other party.

According to another embodiment of the present disclosure, the packet 900 may further include at least one of transmission end identification information for identifying a transmission end that transmits the packet and reception end identifying information for identifying a reception end to receive the packet. Here, the transmission end identification information and the reception end identification information may include, but is not limited to, IP address information, MAC address information, and product identification information, and the like. They may include any information for distinguishing between the reception end and the transmission end in the wireless charging system.

According to still another embodiment of the present disclosure, the packet 900 may further include predetermined group identification information for identifying a reception group when the packet is to be received by a plurality of apparatuses.

FIG. 10 illustrates the types of packets transmitted from a wireless power receiver to a wireless power transmitter according to an embodiment of the present disclosure.

Referring to FIG. 10, packets transmitted from a wireless power receiver to a wireless power transmitter may include a signal strength packet for transmitting strength information about a detected ping signal, an end power transfer packet for requesting the transmission end to stop power transmission, a power control hold-off packet for transmitting time for waiting until power is actually adjusted after receiving a control error packet for control, a configuration packet for transmitting the configuration information about the receiver, an identification packet and an extended identification packet for transmitting identification information about the receiver, a general request packet for transmitting a general request message, a specific request packet for transmitting a specific request message, an FOD status packet for transmitting a reference quality factor value for FO detection, a control error packet for controlling the transmission power of the transmitter, a renegotiation packet for starting renegotiation, a 24-bit received power packet and an 8-bit received power packet for transmitting intensity information about the received power, and a charge status packet for transmitting charge status information about a current load.

The packets to be transmitted from the wireless power receiver to the wireless power transmitter may be transmitted through in-band communication using the same frequency band as that used for wireless power transmission.

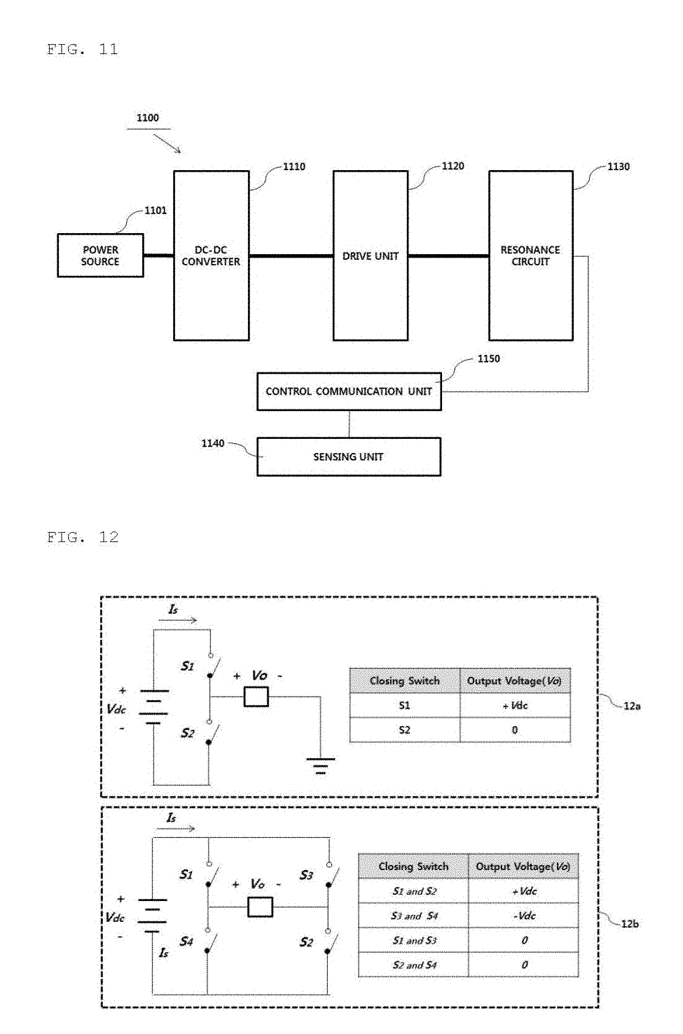

FIG. 11 is a block diagram illustrating a structure of a wireless power control apparatus according to an embodiment.

As an example, the wireless power control apparatus may be mounted in a wireless power transmitter.

Referring to FIG. 11, the wireless power control apparatus 1100 may include a power source unit 1101, a DC-DC converter 1110, a drive unit 1120, a resonance circuit 1130, a sensing unit 1140, and a control communication unit 1150.

The power source unit 1101 may be supplied with DC power through an external power terminal and transmit the DC power to the DC-DC converter 1110.

The DC-DC converter 1110 may convert the intensity of the DC power received from the power source unit 1101 into DC power having a specific intensity. For example, the DC-DC converter 1110 may include a variable transformer capable of controlling the magnitude of the voltage, and may control the intensity of the DC output power according to a predetermined control signal of the control communication unit 1150. However, embodiments are not limited thereto. In another example, the intensity of the DC output power of the DC-DC converter 1110 may have a fixed value.

The drive unit 1120 converts the DC power output from the DC-DC converter 1110 into AC power and provides the AC power to the resonant circuit 1130.

The drive unit 1120 may include a frequency generator configured to generate a reference frequency signal, an inverterr, and a gate driver configured to control a switch provided in the inverter according to the reference frequency signal. Here, the inverter may include a half-bridge inverter and/or a full-bridge inverter. When both the half-bridge inverter and the full-bridge inverter are provided in the drive unit 1120, the drive unit 1120 may drive one of the half-bridge inverter and the full-bridge inverter according to a predetermined control signal of the control communication unit 1150. The control communication unit 1150 may dynamically determine whether to operate the drive unit 1120 in the half-bridge mode or the full-bridge mode. According to one embodiment of the present disclosure, the control communication unit 1150 may adaptively control the bridge modes of the drive unit 1120 according to the intensity of the power required by the wireless power reception apparatus. For example, when the wireless power reception apparatus requires a low power of 5 W, the control communication unit 1120 may control the half-bridge circuit of the drive unit 1120 to be driven. On the other hand, when the wireless power reception apparatus requires a high power of 15 W, the control communication unit 1120 may control the full-bridge circuit of the drive unit 1120 to be driven.

The resonance circuit 1130 is a circuit for realizing resonance by connecting an inductor and a capacitor in series or in parallel. In the case of a series resonance circuit in which an inductor and a capacitor are connected in series, the intensity Iₖ of the current flowing through the resonance circuit is inversely proportional to the inductance R_{L} of the inductor, i.e., the transmission coil, and is proportional to the amplitude E_{V} of the AC voltage applied to the resonance circuit 1130. That is, I_{R}=E_{V}/R_{L}. Therefore, when overcurrent flows through the resonance circuit 1130 and thus heat generation is serious, the control communication unit 1150 may control the inductance value of the resonance circuit 1130 to be increased. In this case, when the inductance value of the resonance circuit 1130 is increased, the total impedance of the resonance circuit 1130 correspondingly increases, and thus the current flowing through the resonance circuit 1130 decreases.

According to an embodiment of the present disclosure, the resonance circuit 1130 may include an impedance adjustment circuit configured to adjust the total impedance of the resonance circuit 1130 according to a predetermined control signal of the control communication unit 1150. For example, the impedance adjustment circuit may include a switch and an inductor. Here, it should be rioted that the number of switches and inductors may depend on the design of an impedance adjustment unit and an impedance adjustment.

When the intensity of the current applied to the resonance circuit 1130 exceeds a predetermined reference value, the control communication unit 1150 may control the impedance adjustment circuit to increase the impedance of the resonance circuit 1130.

In addition, when the temperature measured on the resonance circuit 1130, the control circuit board of the wireless power transmitter, or the like exceeds a predetermined threshold, the control communication unit 1150 may control the impedance adjustment circuit to increase the impedance of the resonance circuit 1130.

The sensing unit 1140 may measure the intensity of the current applied to the resonance circuit 1130, for example, the current flowing through the inductor at predetermined periodic intervals, and transmit a result of the measurement to the control communication unit 1150.

Further, the sensing unit 1140 may measure the temperature of a specific position or component of the wireless power transmitter through the provided temperature sensor and transmit a result of the measurement to the control communication unit 1150.

When the issue of heat generation is not addressed through adjustment of the impedance of the resonance circuit 1130 while the half-bridge inverter of the drive unit 1120 is driven, the control communication unit 1150 may control the bridge modes of the drive unit 1120.

For example, when the temperature of the wireless power transmission apparatus exceeds a predetermined threshold during the transmission of wireless power using the half-bridge circuit, the control communication unit 1120 may primarily increase the total impedance of the resonance circuit 1130. If the temperature does not fall below the predetermined threshold, the control communication unit 1120 may deactivate the half-bridge circuit and activate the full-bridge circuit. That is, to transmit power of the same intensity, the control communication unit 1150 may raise the voltage applied to the resonance circuit 1130 and reduce the intensity of an alternating current, i.e., a ripple current, flowing through the resonance circuit 1130 by activating the full-bridge circuit. Thereby, the control communication unit may control the temperature measured by the sensing unit 1140 to be kept below a predetermined threshold.

The control communication unit 1150 may demodulate an in-band signal received from a wireless power receiver. For example, the control communication unit 1150 may demodulate a control error packet received at intervals of a predetermined period after entering the power transfer phase 440 or 560, and may determine the intensity of the transmitted power based on the demodulated control error packet.

The control communication unit 1150 may modulate a packet to be transmitted to the wireless power receiver and transmit the modulated packet to the resonance circuit 1130.

The sensing unit 1140 may measure a voltage, a current, a power, and a temperature at a specific node, a specific component, or a specific position of the wireless power transmission apparatus. In an example, the sensing unit 1140 may measure the current/voltage/power between the DC-DC converter 1110 and the drive unit 1120 and transmit the result of the measurement to the control communication unit 1150. In another example, the sensing unit 1140 may measure the intensity of the current flowing through the inductor of the resonance circuit 1130 and the magnitude of the voltage applied to the capacitor, and transmit the result of the measurement to the control communication unit 1150. In still another example, the sensing unit 1140 may measure the temperature of the resonance circuit 1130, the control circuit board (not shown), the charging bed, or the like, and transmit the result of the measurement to the control communication unit 1150.

FIG. 12 is a diagram for explaining the basic operation principle of an inverter configured to convert a DC signal into an AC signal in order to facilitate understanding of the present disclosure.

The drive unit 1120 of FIG. 1i may include at least one of a half-bridge inverter and a full-bridge inverter.

Referring to the section indicated by reference numeral 12a, the half-bridge inverter may include two switches S1 and S2, and the output voltage Vo may be changed according to the switch ON/OFF control of the gate driver. For example, when switch S1 is closed and switch S2 is open, the output voltage Vo has a value of +Vdc, which is the input voltage. On the other hand, when switch S1 is open and switch S2 is closed, the output voltage Vo becomes zero. When switches S1 and S2 are alternately closed at predetermined periodic intervals, the half-bridge inverter may output an AC waveform having a corresponding periodicity.

Referring to the section indicated by reference numeral 12b in FIG. 12, the full-bridge inverter may include four switches S1, S2, S3, and S4, and the level of output voltage Vo may have a value of +Vdc, −Vdc or 0 according to the switch ON/OFF control of the gate driver, as shown in the table included in the section indicated by reference numeral 12b. For example, when switches S1 and S2 are closed and the remaining switches are open, the level of output voltage Vo becomes +Vdc. On the other hand, when switches S3 and S4 are closed and the remaining switches are open, the level of output voltage Vo becomes −Vdc.

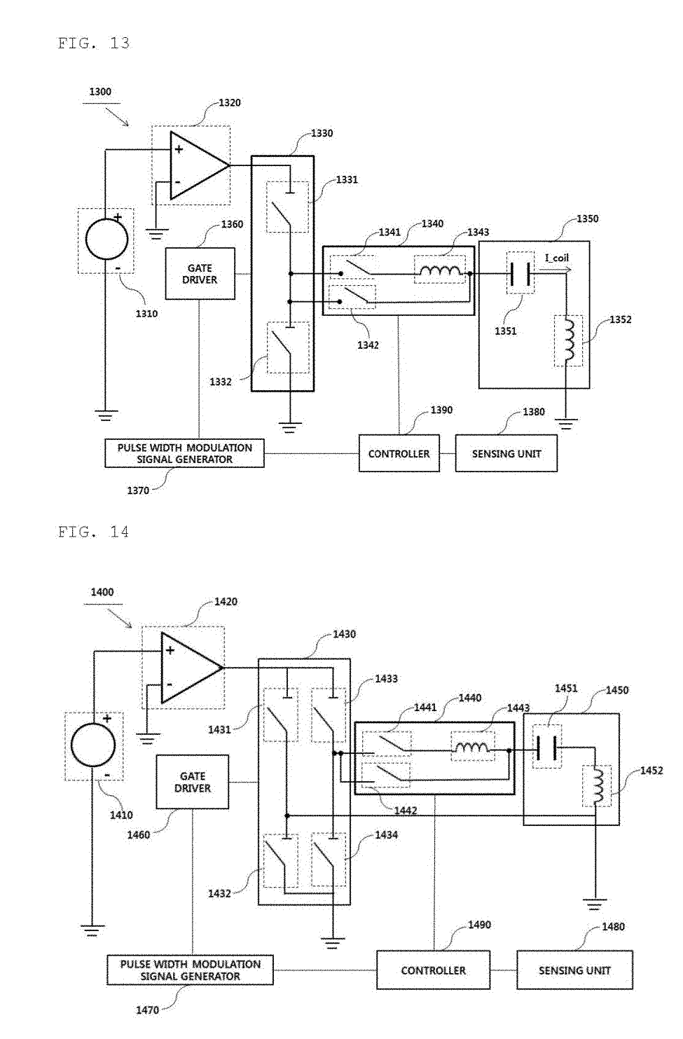

FIG. 13 is an equivalent circuit diagram of a wireless power control apparatus equipped with a half-bridge type inverter according to an embodiment.

For convenience of explanation, the terms “half-bridge inverter” and “first inverter” will be used interchangeably.

Referring to FIG. 13, a wireless power control apparatus 1300 may include a power source unit 1310, a DC/DC converter 1320, a first inverter 1330, an impedance adjustment circuit 1340, a series resonance circuit 1350, a gate driver 1360, a pulse width modulation signal generator 1370, a sensing unit 1380, and a controller 1390.

The first inverter 1330 may include a first switch 1331 and a second switch 1332.

The gate driver 1360 may control the first switch 1331 and the second switch 1332 according to a PWM signal applied by the pulse width modulation signal generator 1370 to control the first inverter 1330 to output an alternating current signal with a specific pattern.

Of course, the pulse width modulation signal generator 1370 may generate a specific PWM signal according to a control signal of the controller 1390. The pulse width modulation signal generator 1370 may dynamically control the phase, frequency, duty rate, and the like of the PWM signal according to the control signal of the controller 1390. In one embodiment, the controller 1380 may adaptively determine at least one of a phase, a frequency, or a duty rate of the PWM signal based on the required power of the wireless power receiver to control the pulse width modulation signal generator 1370.

The impedance adjustment circuit 1340 may include a first impedance adjustment switch 1341, a second impedance adjustment switch 1342, and an impedance adjustment inductor 1342.

The series resonance circuit 1350 may include a resonant capacitor 1351 and a resonant inductor 1352.

When the first impedance adjustment switch 1341 is open and the second impedance adjustment switch 1342 is closed, the total impedance of the resonance circuit is determined based on the resonant capacitor 1351 and the resonant inductor 1352.

On the other hand, when the first impedance adjustment switch 1341 is closed and the second impedance adjustment switch 1342 is open, the total impedance of the resonance circuit is determined by the resonant capacitor 1351, the resonant inductor 1352 and the impedance adjustment inductor 1342. Accordingly, when the first impedance adjustment switch 1341 is closed and the second impedance adjustment switch 1342 is open, the impedance corresponding to the impedance adjustment inductor 1342 is increased compared to a case where the first impedance adjustment switch 1341 is open and the second impedance adjustment switch 1342 is closed.

The sensing unit 1380 may measure the intensity of a current I_coil flowing through the resonant inductor 1352 and transmit the result of the measurement to the controller 1390. For example, the sensing unit 1380 may measure the average intensity of an alternating current I_coil flowing through the resonant inductor 1352 for a unit time at predetermined periodic intervals, and may transmit the result of the measurement to the controller 1390.

The controller 1390 may determine whether impedance adjustment is needed based on the intensity value of the current I_coil received from the sensing unit 1380. When the impedance adjustment is needed as a result of the determination, the controller 1390 may control the first or second impedance adjustment switch 1341 or 1342 to increase or decrease the total impedance of the resonance circuit.

Further, the sensing unit 1380 may measure the temperature of a specific component (or module) or a specific position of the wireless power transmission apparatus, and transmit the result of the measurement to the controller 1390. In one example, the sensing unit 1230 may measure the temperature of the resonance circuit at predetermined periodic intervals. In another example, the sensing unit 1230 may measure the surface temperature of the control circuit board at a specific position, the internal temperature of the housing of the wireless power transmission apparatus, or the temperature of the charging bed at predetermined periodic intervals, but embodiments are not limited thereto.

The controller 1390 may determine whether impedance adjustment is needed based on the temperature measured by the sensing unit 1380. When the impedance adjustment is needed as a result of the determination, the controller 1390 may control the first or second impedance adjustment switch 1341 or 1342 to increase or decrease the total impedance of the resonance circuit.

FIG. 14 is an equivalent circuit diagram of a wireless power control apparatus equipped with a full-bridge inverter according to another embodiment.

For convenience of explanation, the terms “full-bridge inverter” and “second inverter” will be used interchangeably.

Referring to FIG. 14, a wireless power control apparatus 1400 may include a power source unit 1410, a DC/DC converter 1420, a second inverter 1430, an impedance adjustment circuit 1440, a series resonance circuit 1450, a gate driver 1460, a pulse width modulation signal generator 1470, a sensing unit 1480, and a controller 1490.

The second inverter 1430 may include a first switch 1441, a second switch 1432, a third switch 1433, and a fourth switch 1434.

The impedance adjustment circuit 1440 may include a first impedance adjustment switch 1441, a second impedance adjustment switch 1442, and an impedance adjustment inductor 1442.

The series resonance circuit 1450 may include a resonant capacitor 1451 and a resonant inductor 1452.

For the details of the functions and operations of the elements included in the wireless power control apparatus 1400 according to the present embodiment, refer to the description of the elements corresponding to FIG. 13.

While it is illustrated in the embodiments of FIGS. 13 and 14 that the number of impedance adjustment switches included in the impedance adjustment circuit is 2 and the number of impedance adjustment inductors included in the impedance adjustment circuit is 1, this is merely one embodiment. It should be noted that the number of impedance adjustment switches and the number of impedance adjustment inductors may depend on a predefined impedance adjustment unit and a predefined impedance adjustment range. When there are a plurality of impedance adjustment inductors, the inductances of the respective impedance adjustment inductors may be equal to each other. However, embodiments are not limited thereto. Each inductance may be a multiple of a certain value.

In addition, in the embodiments of FIGS. 13 and 14, when the issue of heat generation is not addressed through adjustment of the impedance of the resonance circuit, that is, when the temperature of the resonance circuit does not decrease below a threshold, the controllers 1390 and 1490 may stop power transmission and perform a control operation to output a predetermined warning alarm indicating that an over-temperature condition has occurred. To this end, the wireless power control apparatuses of FIGS. 13 and 14 may further include an alarm unit (not shown).

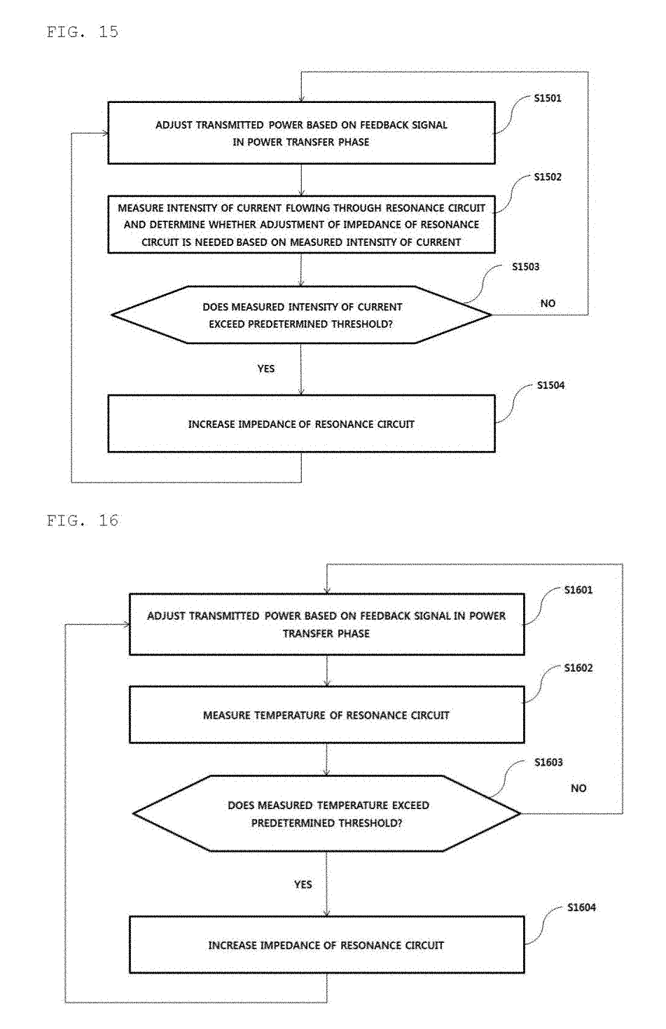

FIG. 15 is a flowchart illustrating a wireless power control method according to an embodiment.

Referring to FIG. 15, in the power transfer phase, a wireless power transmission apparatus may adjust the intensity of power transmitted through a resonance circuit based on a feedback signal received from a wireless power reception apparatus (31501). Here, the intensity of the transmitted power may be adjusted by controlling an operating frequency for generating AC power, or a duty rate or phase of a PWM signal for controlling an inverter switch, but embodiments are not limited thereto. The intensity of the transmitted power may be adjusted by controlling a DC/DC converter.

The wireless power transmission apparatus may measure the intensity of a current flowing through the resonance circuit (S1502). For example, the wireless power transmission apparatus may measure an average intensity of alternating current flowing through the resonance circuit for a unit time at predetermined periodic intervals.

The wireless power transmission apparatus may compare whether the measured intensity of the current exceeds a predetermined threshold (S1503).

When the intensity exceeds the predetermined threshold as a result of the comparison, the wireless power transmission apparatus may perform a control operation to increase the total impedance of the resonance circuit (S1504). Thereafter, the wireless power transmission apparatus may perform operation 1501 described above. For example, the wireless power transmission apparatus may increase the total impedance of the resonance circuit by controlling corresponding impedance adjustment switches of the impedance adjustment circuits 1340 and 1440 shown in FIGS. 13 to 14, but embodiments are not limited thereto. The circuit configuration capable of increasing the total impedance of the resonance circuit may be applied differently according to the design by a person skilled in the art.

When the measured intensity of the current does not exceed the predetermined threshold as a result of the comparison in operation 1503, the wireless power transmission apparatus may perform operation 1501 described above.

While it is illustrated in the embodiment of FIG. 15 that the impedance of the resonance circuit is adjusted based on the temperature measured in the power transfer phase, that is, in the charging state, this is merely one embodiment. It should be noted that a wireless power transmission apparatus according to another embodiment may adjust the impedance of the resonance circuit based on the temperature measured in any of the phases disclosed in FIGS. 4 and 5.

FIG. 16 is a flowchart illustrating a wireless power control method according to another embodiment.

Referring to FIG. 16, in the power transfer phase, the wireless power transmission apparatus may adjust the intensity of power transmitted through the resonance circuit based on a feedback signal received from a wireless power reception apparatus (S1601). Here, the intensity of the transmitted power may be adjusted by controlling an operating frequency for generating AC power, or a duty rate or phase of a PWM signal for controlling an inverter switch, but embodiments are not limited thereto. The intensity of the transmitted power may be adjusted by controlling a DC/DC converter.

The wireless power transmission apparatus may measure the temperature of the resonance circuit (S1602). For example, the wireless power transmission apparatus may measure the temperature around an inductor constituting the resonance circuit at predetermined periodic intervals.

The wireless power transmission apparatus may compare whether the measured temperature exceeds a predetermined threshold (S1603).

When the temperature exceeds the predetermined threshold as a result of the comparison, the wireless power transmission apparatus may perform a control operation to increase the total impedance of the resonance circuit (S1604). Thereafter, the wireless power transmission apparatus may perform operation 1601 described above. For example, the wireless power transmission apparatus may increase the total impedance of the resonance circuit by controlling corresponding impedance adjustment switches of the impedance adjustment circuits 1340 and 1440 shown in FIGS. 13 to 14, but embodiments are not limited thereto. The circuit configuration capable of increasing the total impedance of the resonance circuit may be applied differently according to the design by a person skilled in the art.

In one example, the impedance adjustment circuit may include at least one capacitor, and the wireless power transmission apparatus may adjust the total impedance of the resonance circuit by adjusting the total capacitance of the resonance circuit according to the measured temperature.

In another example, the impedance adjustment circuit may include at least one inductor and a capacitor which are configured to adjust the total impedance of the resonance circuit. In this case, the wireless power transmission apparatus may adjust the total impedance of the resonance circuit by adjusting the inductance and the capacitance of the impedance adjustment circuit according to the measured temperature.

When the measured temperature does not exceed the predetermined threshold as a result of the determination in operation 1603, the wireless power transmission apparatus may enter operation 1601 described above to continue to perform charging.

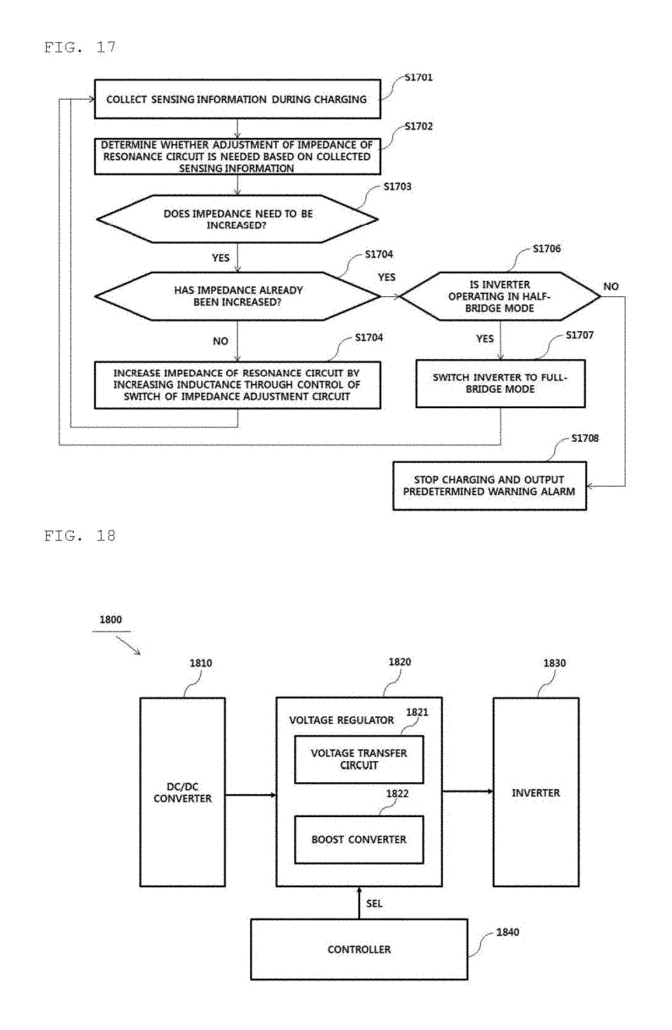

FIG. 17 is a flowchart illustrating a wireless power control method according to still another embodiment.

Referring to FIG. 17, the wireless power transmission apparatus collects sensing information through various sensors provided therein during transmission of power to a corresponding wireless power reception apparatus, that is, during charging (S1701). Here, the sensors may include a temperature sensor configured to measure a temperature, and a current sensor configured to measure the intensity of a current.

The wireless power transmission apparatus may determine whether adjustment of the impedance of the resonance circuit is needed based on the collected sensing information (S1702). In an example, when the temperature of the resonance circuit currently exceeds a predetermined threshold, the wireless power transmission apparatus may determine that the impedance of the resonance circuit needs to be adjusted. In another example, the wireless power transmission apparatus may determine whether the impedance of the resonance circuit needs to be adjusted by comparing whether the average intensity of an alternating current applied to the resonance circuit for a unit time exceeds a predetermined threshold.

When the impedance of the resonance circuit needs to be adjusted as a result of the determination, the wireless power transmission apparatus may check whether the impedance of the resonance circuit has already been increased (S1704). For example, the wireless power transmission apparatus may check whether the impedance of the resonance circuit has already been increased, based on the ON/OFF state of the impedance adjustment switches of the impedance adjustment circuits of FIGS. 13 and 14.

When the impedance of the resonance circuit has not been increased as a result of the checking, that is, when it is allowed to increase the total impedance of the resonance circuit, the wireless power transmitter may increase the total impedance of the resonance circuit by increasing the inductance through control of the impedance adjustment switch of the impedance adjustment circuit (S1704). Thereafter, the wireless power transmission apparatus may enter operation 1701 and collect sensing information.

When the impedance of the resonance circuit has already been increased as a result of the checking in operation 1704, the wireless power transmission apparatus may check whether the inverter is currently operating in the half-bridge mode (S1706).

When the inverter is operating in the half-bridge mode as a result of the checking, the wireless power transmission apparatus may switch the inverter to the full-bridge mode (S1707).

When the inverter is operating in the full-bridge mode as a result of the checking in operation 1704, the wireless power transmission apparatus may stop charging and output a predetermined warning alarm (S1708).

While it is illustrated in the embodiment of FIG. 17 that whether the impedance has already been increased is checked in operation 1704, and then the impedance of the resonance circuit is increased or the bridge mode of the inverter is switched according to the result of the check, this is merely one embodiment.

In another embodiment, when it is not allowed to increase the total impedance of the resonance circuit anymore, the wireless power transmission apparatus may switch the inverter from the half-bridge mode to the full-bridge mode. When it is allowed to increase the total impedance of the resonance circuit, the wireless power transmission apparatus may increase the total impedance of the resonance circuit by increasing the total inductance of the resonance circuit through control of the impedance adjustment switch of the impedance adjustment circuit.

FIG. 18 is a block diagram illustrating a voltage regulator of a wireless power transmitter according to an embodiment.

Referring to FIG. 18, a voltage regulator 1820 of a wireless power transmitter 1800 may be provided between a DC/DC converter 1810 and an inverter 1830, and may process a DC voltage output from the DC/DC converter 1810 according to a mode selection signal SEL of a controller 1840 and transmit the processed DC voltage to the inverter 1830. The DC/DC converter 1810, the inverter 1830 and the control unit 1840 may refer to the DC/DC converter 611, the inverter 612 and the controller 640 shown in FIG. 6, respectively.

The controller 1840 may receive a result of measurement of an internal temperature of the wireless power transmitter 1800 from the sensing unit 650 and determine whether the wireless power transmitter 1800 is in an over-temperature condition. In addition, the controller 1840 may determine whether a wireless power receiver is in an over-temperature condition based on an over-temperature indicator received from the wireless power receiver. The controller 1840 may change the power transmission mode upon determining that the wireless power transmitter 1800 or the wireless power receiver is in the over-temperature condition.

Here, the power transmission mode may include a low power mode and a medium power mode. The medium power mode refers to a mode in which power higher than in the low power mode may be transmitted to the wireless power receiver 700.

The wireless power receiver may be defined to support a specific power transmission mode. The specific power transmission mode may be determined according to the information about the required power of the wireless power receiver, which indicates the intensity of a current required for the wireless power receiver. For example, a device such as a laptop computer having a high required power may support both the low power mode for receiving high power and the medium power mode for receiving low power. As another example, a specific smartphone requiring low power may support only the low power mode without supporting the medium power mode.

The inverter 1830 may include a half-bridge inverter and/or a full-bridge inverter. The controller 1840 may dynamically determine whether to drive the half-bridge inverter or the full-bridge inverter according to the power transmission mode determined according to the required power of the wireless power receiver. In one example, when the wireless power receiver requires low power of 5 W, the controller 1840 may determine that the power transmission mode is the low power mode and perform a control operation to drive the half-bridge circuit of the inverter 1840. On the other hand, when the wireless power receiver requires high power of 15 W, the controller 1840 may determine that the power transmission mode is the medium power mode and perform a control operation to drive the full-bridge circuit of the inverter 1830.

This is because the voltage range of the half-bridge circuit (e.g., 0 to VDD (V)) is narrower than the voltage range of the full-bridge circuit (e.g., −VDD (V) to VDD (V)) and the full-bridge circuit is capable of transmitting higher power than the half-bridge circuit at the same current.

When the controller 1840 determines that the wireless power transmitter 1800 or the wireless power receiver is in an over-temperature condition with the current power transmission mode set to the low power mode, the controller 1840 may change the power transmission mode to the medium power mode to address the over-temperature condition. Since heat generation in the wireless power transmitter or the wireless power receiver depends on the current flowing through the transmission coil or the reception coil, the current flowing through the transmission coil or the receiving coil should be lowered to reduce generated heat. In order to lower the current flowing through the transmission coil or the reception coil while maintaining the power transmitted by the wireless power transmitter 1800, the controller 1840 may change the current power transmission mode to the medium power mode in which driving the full-bridge circuit having a wide voltage range is allowed, which.

The controller 1840 may perform a control operation to drive the full-bridge circuit of the inverter 1830 according to the medium power mode, and a reduced current (e.g., a current reduced by half) may flow through the transmission coil 1800 while the wireless power transmitter 1800 transmits the same power. As a result, a reduced current may flow through the reception coil of the wireless power receiver.

When the wireless power receiver is a receiver that does not support the medium power mode according to the information about the required power of the receiver, the controller 1840 may not be allowed to change the power transmission mode to reduce the currents of the transmission coil and the reception coil even if the over-temperature condition occurs. Therefore, the controller 1840 may reduce the currents of the transmission coil and the reception coil by adjusting the impedance of the resonance circuit connected to the inductor 1830.

The resonance circuit is a circuit configured to realize resonance by connecting an inductor and a capacitor in series or in parallel. Here, the inductor may represent the transmission coil. In the case of a series resonance circuit in which an inductor and a capacitor are connected in series, the intensity IR of the current flowing through the resonance circuit is inversely proportional to the inductance RL of the inductor, i.e., the transmission coil, and is proportional to the amplitude EV of the AC voltage applied to the resonance circuit 1130. That is, IR=EV/RL. Therefore, when an over-temperature condition occurs, the controller 1840 may perform a control operation to increase the inductance of the resonance circuit. In this case, when the inductance of the resonance circuit is increased, the total impedance of the resonance circuit is correspondingly increased, and thus the current flowing through the resonance circuit is reduced.

The resonance circuit may include an impedance adjustment circuit configured to adjust the total impedance of the resonance circuit according to a predetermined control signal of the controller 1840. For example, the impedance adjustment circuit may include a switch and an inductor. Here, it should be noted that the number of switches and inductors may depend on the design of an impedance adjustment unit and an impedance adjustment range.

That is, when the wireless power receiver is a receiver that does not support the low power mode, the controller 1840 may reduce the currents of the transmission coil and the reception coil by adjusting the impedance of the resonance circuit through the impedance adjustment circuit.

However, when the current in the transmission coil is reduced, the power output through the transmission coil is also reduced. In the case where the power received by the wireless power receiver decreases below a certain power, the wireless power receiver may determine that violation of a preset power transfer contract has occurred. In this case, the wireless power receiver enters the selection phase from the power transfer phase, and the wireless power transmitter 800 stops power transmission.

In other words, wireless charging may be interrupted against the wireless power receiver supporting only the low power mode when an over-temperature condition occurs. However, this effect may be prevented with the wireless power transmitter 1800 including the voltage regulator 1820 according to an embodiment.

The voltage regulator 1820 may include a voltage transfer circuit 1821 and a boost converter 1822.

Each of the voltage transfer circuit 1821 and the boost converter 1822 may be activated or deactivated according to a mode selection signal SEL. The mode selection signal SEL is a signal for selecting a mode of the voltage regulator 1820.

The voltage regulator 1820 may operate in either a normal mode or a boost mode. The boost mode is a mode in which the voltage applied to the inverter 1830 is boosted to prevent interruption of charging in the event that the current in the transmission coil is reduced due to an over-temperature condition during operation of the wireless power transmitter in the low power mode. That is, when the wireless power receiver supports only the low power mode, the controller 840 may prevent the transmitted power from decreasing due to the decrease in the current in the transmission coil by widening a voltage range of the half-bridge circuit (from a range of 0 to VDD V to a range of 0 to VDD′ V) by boosting the voltage applied to the inverter 1830 (from VDD to VDD′, where VDD<VDD′).

The normal mode may refer to an operation mode in a time region that is not for the boost mode.

According to one embodiment, when an over-temperature condition occurs, the controller 840 may reduce the current in the transmission coil step by step. In the case where the over-temperature condition is not addressed even when the current in the transmission coil reaches a predetermined threshold (a current at which interruption of charging may occur), the controller may operate the voltage regulator 1820 in the boost mode before further reducing the current in the transmission coil.

According to another embodiment, when an over-temperature condition occurs, the controller 1840 may immediately reduce the current in the transmission coil to a predetermined threshold (a current at which interruption of charging may occur). In the case where the over-temperature condition is not addressed even when the current in the transmission coil reaches the predetermined threshold, the controller may operate the voltage regulator 1820 in the boost mode before further reducing the current in the transmission coil.

The voltage transfer circuit 1821 may be activated according to a mode selection signal SEL indicating the normal mode. The activated voltage transfer circuit 821 may transfer the output voltage of the DC/DC converter 1810 to the inverter 1830.

The voltage transfer circuit 1821 may be deactivated according to a mode selection signal SEL indicating the boost mode. The deactivated voltage transfer circuit 821 may interrupt the output voltage of the DC/DC converter 1810 so as not to be transmitted to the inverter 1830.

The boost converter 1822 may be activated according to the mode selection signal SEL indicating the boost mode. The activated boost converter 1822 may boost the output voltage of the DC/DC converter 1810 and transfer the boosted voltage to the inverter 1830.

The boost converter 1822 may be deactivated according to the mode selection signal SEL indicating the normal mode. The deactivated boost converter 1822 may not perform the boost operation on the output voltage of the DC/DC converter 1810.

According to an embodiment of the present disclosure, even when an over-temperature condition occurs during power transmission to a wireless power receiver supporting only the low power mode, the wireless power transmitter 1800 may minimize heat generation while maintaining the power transmission state without interruption of charging.

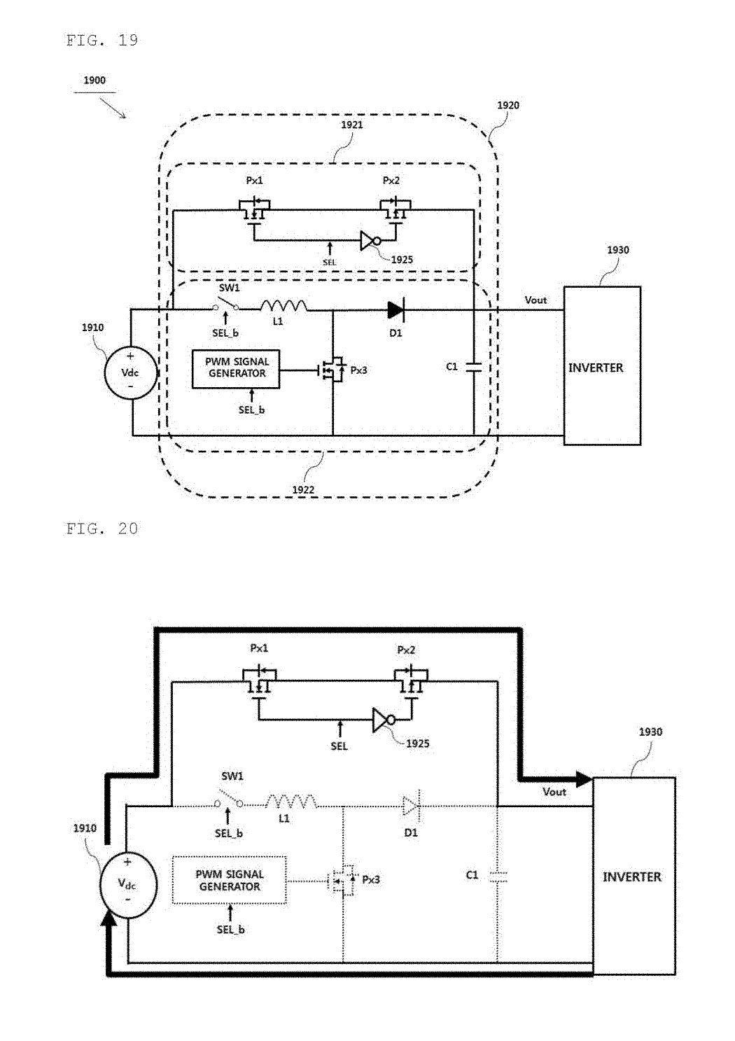

FIG. 19 is a circuit diagram showing a voltage regulator according to an embodiment.

FIG. 20 is a diagram illustrating operation of the voltage regulator of FIG. 9 in a normal mode.

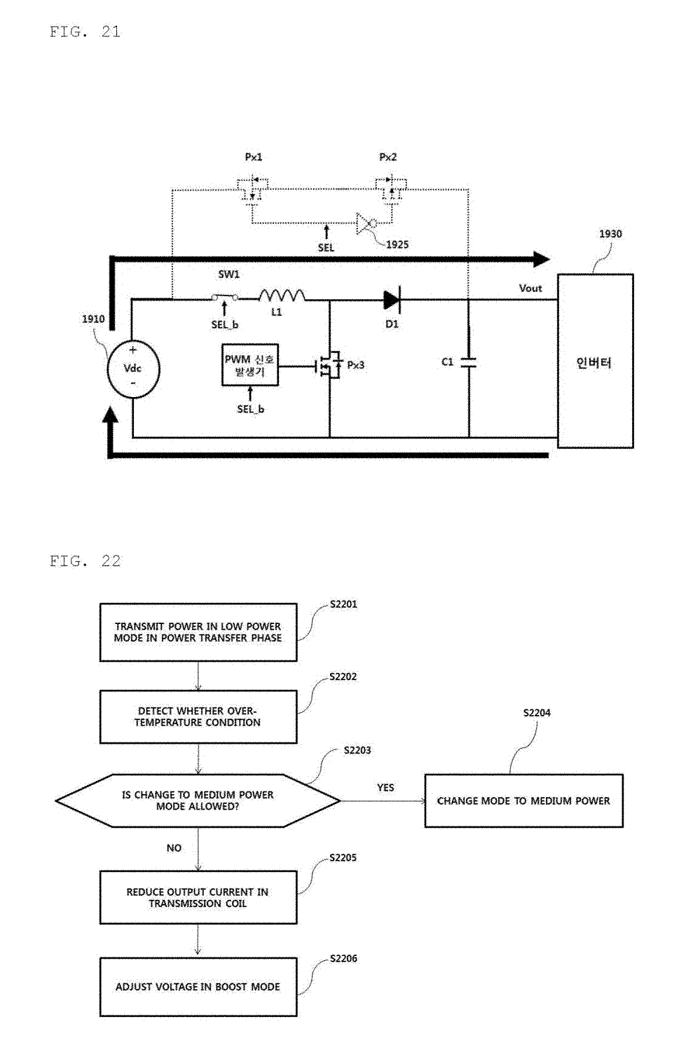

FIG. 21 is a diagram illustrating operation of the voltage regulator of FIG. 9 in a boost mode.

Referring to FIGS. 1.9 to 21, a wireless power transmitter 1900 represents one embodiment of the configuration of the wireless power transmitter 1800 shown in FIG. 18.

The DC/DC converter 1910 is shown as one DC voltage source from the perspective of a voltage regulator 1920.

The voltage regulator 1920 may be implemented with a circuit configuration as shown in FIG. 19, but embodiments are not limited thereto.

The voltage regulator 1920 may include a voltage transfer circuit 1921 and a boost converter 1922.

The voltage transfer circuit 1921 may include a first power transistor Px1 and a second power transistor Px2, which are connected between the DC/DC converter 1910 and an inverter 1930. The first power transistor Px1 may be implemented as a PNP transistor and the second power transistor Px2 may be implemented as an NPN transistor. The first power transistor Px1 and the second power transistor Px2 may receive a mode selection signal SEL and an inverted mode selection signal SEL_b, which is obtained by an inverter 1925 by inverting the mode selection signal SEL, as a gate input, respectively.

The boost converter 1922 may include a first switch SW1 configured to operate according to the inverted mode selection signal SEL_b, a first inductor L, a first diode D1, a first capacitor C1, a third power transistor Px3, and a Pulse Width Modulation (PWM) signal generator configured to operate according to the inverted mode selection signal SEL_b. The inverted mode selection signal SEL_b is a signal having a phase opposite to that of the mode selection signal SEL_b and may be generated by the inverter 1925, which inverts the mode selection signal SEL.

The third power transistor Px3 may be implemented as a PNP transistor. The PWM signal generator may be activated according to the inverted mode selection signal SEL_b to generate a PWM signal having a phase, frequency, and duty rate determined according to control of the controller 1840.

The inverter 1930 may be connected to the voltage regulator 1920 and be operated by receiving an output voltage Vout.

In FIG. 20, it is assumed that the voltage regulator 1920 receives a mode selection signal SEL of a first level (e.g., HIGH level) indicating the normal mode operation.

The first switch SW1 of the boost converter 1922 is turned off upon receiving the inverted mode selection signal SEL_b of a second level (e.g., LOW level). As a result, no current flows into the boost converter 1922 and thus the boost converter 1922 does not operate as shown in FIG. 20.

When the mode selection signal SEL of the first level is applied to the voltage transfer circuit 1921, the first power transistor Px1 and the second power transistor Px2 are turned on, respectively, allowing current to flow. When it is assumed that a voltage drop due to the first power transistor Px1 and the second power transistor Px2 is ignored, the output voltage Vout is equal to Vdc, which is the output voltage of the DC/DC converter 1910.

That is, when the voltage regulator 1920 receives the mode selection signal SEL of the first level (e.g., HIGH level) indicating the normal mode operation, the voltage regulator 1920 may output the output voltage of the DC/DC converter 1910 to the inverter 1930.

In FIG. 21, it is assumed that the voltage regulator 1920 receives a mode selection signal SEL of the second level (e.g., LOW level) indicating the boost mode operation.

When the mode selection signal SEL of the second level is applied to the voltage transfer circuit 1921, the first power transistor Px1 and the second power transistor Px2 are turned off, respectively, and thus the current does not flow. Further, the current is not allowed to flow from the first power transistor Px1 to the second power transistor Px2 and from the second power transistor Px2 to the first power transistor Px1 due to the diodes in the first power transistor Px1 and the second power transistor Px2. Thus, the voltage transfer circuit 1921 does not operate, as shown in FIG. 21.

The first switch SW1 of the boost converter 1922 is turned on upon receiving an inverted mode selection signal SEL_b of the first level (e.g., HIGH level). Then, a current may flow into the boost converter 1922, and the PWM signal generator may be activated to generate a PWM signal having a first duty rate.

Regarding operation of the boost converter 1922, as the third power transistor Px3 is turned on at the HIGH level of the PWM signal and a current flows from the DC/DC converter 1910 to the first inductor L1, energy is accumulated in a first inductor L1. At this time, the first diode D1 is reverse biased and turned off.

The third power transistor Px3 may be turned off at the LOW level of the PWM signal and the energy accumulated in the first inductor L1 may be accumulated in the first capacitor C1 via the first diode D1, which is in an On state.

This operation is repeated on a cycle of a switching period, and the output voltage Vout may have a relation to the output voltage of the DC/DC converter 1910, Vdc. The relation may be represented as Vout=Vdc/(1−D). Here, D denotes a duty ratio (a proportion of time of the HIGH level in one period).

The controller 1840 may transfer the output voltage Vout of a specific level to the inverter 1930 by adjusting the duty ratio. For example, the controller 1840 may control the boost converter 1922 to boost Vdc of 12 V to Vout of 14 V. However, embodiments are not limited thereto. The specific level may be determined based on the information about the required power of the wireless power receiver and the current in the transmission coil.

That is, when the voltage regulator 1920 receives a mode selection signal SEL of the second level (e.g., LOW level) indicating the boost mode operation, the voltage regulator 1920 may boost the output voltage of the DC/DC converter 1910 at a certain rate and output the boosted voltage to the inverter 1930.

FIG. 22 is a flowchart illustrating operation of a wireless power transmitter according to an embodiment.

Referring to FIG. 22, the wireless power transmitter 1800 may enter the power transfer phase and transmit power to a wireless power receiver in the low power mode (S2201).

The controller 1840 may detect whether an over-temperature condition has occurred based on a result of temperature sensing in the wireless power transmitter 800 or an over-temperature indicator of the wireless power receiver (S2202).

The controller 1840 may determine whether changing the power transmission mode of the wireless power transmitter to the medium power mode is allowed based on the information about the required power of the wireless power receiver (S2203).

When the wireless power receiver is an apparatus supporting the medium power mode according to the information about the required power of the wireless power receiver, the controller 1840 may change the power transmission mode of the wireless power transmitter to the medium power mode to transit power (S2204). Then, the operation of the half-bridge inverter of the inverter 1830 may be stopped and the full-bridge inverter may be driven.

When the wireless power receiver is an apparatus that does not support the medium power mode according to the information about the required power of the wireless power receiver, the controller 1840 may adjust the impedance of the resonance circuit connected to the inductor 1830 to reduce the currents in the transmission coil and the reception coil (S2205).

In the case where the over-temperature condition is not addressed even when the current in the transmission coil reaches a predetermined threshold, the controller 1840 may operate the voltage regulator 1820 in the boost mode to boost the voltage applied to the inverter, thereby preventing interruption of charging (S2206).

The methods according to embodiments described above may be implemented as a program to be executed on a computer and stored in a computer-readable recording medium. Examples of the computer-readable recording medium include ROM, RAM, CD-ROM, magnetic tapes, floppy disks, and optical data storage devices.

The computer-readable recording medium may be distributed to a computer system connected over a network, and computer-readable code may be stored and executed thereon in a distributed manner. Functional programs, code, and code segments for implementing the method described above may be easily inferred by programmers in the art to which the embodiments pertain.

It is apparent to those skilled in the art that the present disclosure may be embodied in specific forms other than those set forth herein without departing from the spirit and essential characteristics of the present disclosure.

Therefore, the above embodiments should be construed in all aspects as illustrative and not restrictive. The scope of the disclosure should be determined by the appended claims and their legal equivalents, and all changes coming within the meaning and equivalency range of the appended claims are intended to be embraced therein.

### INDUSTRIAL APPLICABILITY

The present disclosure may be applied to a wireless power transmission apparatus or a wireless power control apparatus that controls power transmitted to a wireless power reception apparatus.

1-10. (canceled)

11. A method of controlling wireless power in a wireless power transmission apparatus, the method comprising:
measuring an intensity of a current flowing through a resonance circuit during power transmission to a wireless power reception apparatus;
determining whether adjustment of an impedance for the resonance circuit is needed by comparing the measured intensity of the current with a first threshold; and
when the adjustment of the impedance is needed as a result of the determining, adjusting the impedance by changing a total inductance of the resonance circuit.

12. The method according to claim 11, wherein the total inductance of the resonance circuit is changed using an impedance adjustment circuit provided at a front end of the resonance circuit, and
wherein, when the measured intensity of the current exceeds the first threshold, the impedance is increased by increasing the total inductance of the resonance circuit.

13. The method according to claim 12, wherein the resonance circuit is a series resonance circuit configured by connecting a resonant capacitor and a resonant inductor in series.

14. The method according to claim 13, wherein the impedance adjustment circuit comprises an impedance adjustment switch and an impedance adjustment inductor, and
wherein the impedance adjustment inductor is connected in series to the series resonance circuit through control of the impedance adjustment switch to increase the total inductance of the resonance circuit.

15. The method according to claim 14, wherein the impedance adjustment switch comprises:
a first impedance adjustment switch having one end connected to an inverter and an opposite end connected in series to the impedance adjustment inductor; and
a second impedance adjustment switch having one end connected to an inverter and an opposite end connected between the impedance adjustment inductor and the resonant capacitor.

16. The method according to claim 15, further comprising:
outputting a predetermined warning alarm when the intensity of the current flowing through the resonance circuit does not decrease below the first threshold after the impedance is increased.

17. The method according to claim 15, wherein the inverter comprises at least one of a half-bridge inverter and a full-bridge inverter.

18. The method according to claim 11, further comprising:
measuring a temperature of a resonance circuit during power transmission to the wireless power reception apparatus;
determining whether the adjustment of the impedance for the resonance circuit is needed by comparing the measured temperature with a second threshold; and
when the adjustment of the impedance is needed as a result of the determining, adjusting the impedance by changing the total inductance of the resonance circuit.

19. The method according to claim 18, wherein, when the measured temperature exceeds the second threshold, the impedance is increased by increasing the total inductance of the resonance circuit.

20. A wireless power transmission apparatus comprising:
a resonance circuit;
an inverter configured to provide an alternating current power to the resonance circuit;
an impedance adjustment circuit arranged between the inverter and the resonance circuit and configured to adjust a total impedance of the resonance circuit;
a first sensor configured to measure an intensity of a current flowing through the resonance circuit during power transmission; and
a controller configured to determine whether impedance adjustment of the resonance circuit is needed by comparing the measured intensity of the current with a first threshold and to adjust the total impedance of the resonance circuit by controlling the impedance adjustment circuit when the impedance adjustment is needed as a result of the determining.

21. The wireless power transmission apparatus according to claim 20, wherein, when the measured intensity of the current exceeds the first threshold, the controller controls the impedance adjustment circuit to increase a total inductance of the resonance circuit to increase the total impedance of the resonance circuit.

22. The wireless power transmission apparatus according to claim 21, wherein the resonance circuit is a series resonance circuit configured by connecting a resonant capacitor and a resonant inductor in series.

23. The wireless power transmission apparatus according to claim 22, wherein the impedance adjustment circuit comprises an impedance adjustment switch and an impedance adjustment inductor, and
wherein the impedance adjustment inductor is connected in series to the series resonance circuit through control of the impedance adjustment switch to increase the total inductance of the resonance circuit.

24. The wireless power transmission apparatus according to claim 23, wherein the impedance adjustment switch comprises:
a first impedance adjustment switch having one end connected to an inverter and an opposite end connected in series to the impedance adjustment inductor; and
a second impedance adjustment switch having one end connected to an inverter and an opposite end connected between the impedance adjustment inductor and the resonant capacitor.

25. The wireless power transmission apparatus according to claim 20, wherein the inverter comprises at least one of a half-bridge inverter and a full-bridge inverter.

26. The wireless power transmission apparatus according to claim 21, wherein, when the intensity of the current flowing through the resonance circuit does not decrease below the first threshold after the impedance is increased, the controller stops the power transmission and outputs a predetermined warning alarm.

27. The wireless power transmission apparatus according to claim 23, further comprising a second sensor configured to measure a temperature during the power transmission,
wherein the controller determines whether adjustment of the impedance of the resonance circuit is needed by comparing the measured temperature with a predetermined second threshold, and controls the impedance adjustment circuit to adjust the total impedance of the resonance circuit when the impedance adjustment is needed as a result of the determining.

28. The wireless power transmission apparatus according to claim 27, wherein, when the measured temperature exceeds the second threshold, the controller controls the impedance adjustment circuit to increase the total inductance of the resonance circuit to increase the impedance.

29. The wireless power transmission apparatus according to claim 27, further comprising:
a DC/DC converter configured to supply DC power to the inverter; and
a voltage regulator configured to boost an output voltage of the DC/DC converter and deliver the boosted voltage to the inverter,
wherein, when an over-temperature is detected during power transmission in a low power mode based on the temperature measured by the second sensor, the controller determines whether changing a power transmission mode to a medium power mode is allowed based on a required power of a wireless power receiver, and
wherein, when changing the power transmission mode to the medium power mode is not allowed, the controller controls the voltage regulator to boost the output voltage of the DC/DC converter.

30. The wireless power transmission apparatus according to claim 29, wherein, when changing the power transmission mode to the medium power mode is not allowed, the voltage regulator is switched from a normal mode to a boost mode to boost the output voltage of the DC/DC converter, and
wherein, in the normal mode, the output voltage of the DC/DC converter is directly transmitted to the inverter.
